(19) United States
(12) Patent Application Publication
(10) Pub. No.: US 2026/0040080 A1
(43) Pub. Date: Feb. 5, 2026

(54) SYSTEM AND METHOD FOR SCALABLE AUTHENTICATION AND DATA MANAGEMENT IN A SMART CITY NETWORK

(71) Applicant: Osama Ahmed KHASHAN, Abu Dhabi (AE)

(72) Inventor: Osama Ahmed KHASHAN, Abu Dhabi (AE)

(21) Appl. No.: 19/357,981

(22) Filed: Oct. 14, 2025

(51) Int. Cl. H04W 12/60; G16Y 30/10; H04L 9/00; H04L 9/32; H04W 12/041; H04W 12/069; H04W 12/106; H04W 60/00

(52) U.S. Cl. CPC H04W 12/66; H04L 9/3236; H04L 9/3297; H04L 9/50; H04W 12/041; H04W 12/069; H04W 12/106; H04W 60/00; G16Y 30/10; H04L 2209/463; H04L 2209/80

(57) ABSTRACT

The present invention relates to the field of smart city networks, specifically to systems and methods for enhancing security, scalability, and data integrity. More particularly, the invention focuses on a decentralized system for authentication and data management in Internet of Things (IoT) ecosystems within a smart city context. The system addresses critical challenges in conventional centralized architectures, such as single points of failure, scalability bottlenecks, and vulnerabilities to malicious attacks. By integrating a multi-layered approach that combines elliptic curve cryptography for secure node registration, a trust analysis model for real-time behavioral and data trustworthiness assessment, and a blockchain network for decentralized, immutable transaction verification, this system provides a robust and resilient solution. The system ensures secure communication between IoT nodes and fog servers, validates data integrity, and maintains a transparent and tamper-proof ledger of activities, thereby facilitating reliable and efficient operation of various smart city services.

### FIELD OF THE INVENTION

The present disclosure relates to the field of smart city technologies, and more particularly to a system and method for scalable authentication and secure data management in smart city networks. The invention is directed towards enabling reliable identity verification, efficient access control, and secure handling of large-scale heterogeneous data generated by interconnected devices, services, and infrastructures within a smart city ecosystem.

### BACKGROUND OF THE INVENTION

In the rapidly evolving technological landscape, the Internet of Things (IoT) has emerged as a transformative paradigm, driving connectivity among heterogeneous, distributed, and resource-constrained devices. This interconnected ecosystem underpins the very foundation of smart city development, wherein diverse IoT-enabled infrastructures converge to deliver intelligent urban solutions. These solutions range from smart transportation, utilities, healthcare, and surveillance to energy management and education systems, collaboratively optimizing resources and enhancing the quality of life for citizens.

Modern smart cities, unlike traditional urban infrastructures managed predominantly by governmental entities, integrate multi-stakeholder ecosystems involving both public and private organizations. Transportation authorities, utility providers, and private service operators each maintain discrete ICT infrastructures, yet these systems must interoperate cohesively through central or federated decision-making points. Seamless data exchange and real-time analytics from distributed sensors and devices are indispensable for enabling services such as traffic optimization, predictive utilities, and context-aware citizen advisories. This vision necessitates robust, scalable, and interoperable frameworks for both data management and device-level authentication.

However, realizing such interconnected city ecosystems introduces significant challenges at both technological and security levels. On the technological side, scalability, interoperability, and compatibility among heterogeneous IoT systems remain open obstacles. Simultaneously, challenges in security and privacy involve safeguarding against breaches in authentication, confidentiality, and integrity of the vast and sensitive data generated. These challenges are aggravated by the resource limitations of IoT nodes, including constrained computation power, limited storage, and low energy availability, rendering conventional cryptographic and authentication schemes impractical.

Traditional centralized authentication mechanisms rely on computationally intensive cryptographic techniques, increasing latency, draining energy from IoT devices, and creating single points of vulnerability. Moreover, the heterogeneity of devices and communication technologies, ranging from ZigBee and Wi-Fi to next-generation 5G/6G cellular networks, further complicates seamless interoperability across city environments. As the volume of big data generated within smart cities escalates, efficient storage, processing, and data-sharing mechanisms are also increasingly critical.

Cloud computing has been widely considered to address storage and computational deficiencies; however, its centralized nature introduces latency, bandwidth congestion, and single-point failures, making it unsuitable for delay-sensitive smart city applications such as real-time surveillance, traffic monitoring, and instant authentication. To overcome these limitations, fog computing has emerged as a strategic alternative, extending computation and storage capabilities closer to the IoT edge. While fog nodes reduce communication delays and enhance responsiveness, securing communication and authentication across such geographically distributed nodes remains an open research challenge due to the heterogeneous communication protocols and diverse device ecosystems.

To address these unresolved security challenges, blockchain technology has been investigated for IoT-enabled smart cities. Its decentralized and tamper-resistant architecture ensures transparent authentication and secure data sharing, while also supporting trust establishment via smart contracts for services such as traffic control, utility management, and healthcare data exchange. Despite these advantages, conventional blockchain solutions face scalability challenges, primarily due to latency in consensus protocols, limited throughput, and high resource consumption. These bottlenecks are particularly restrictive for resource-constrained IoT devices requiring lightweight, real-time, and energy-efficient authentication schemes.

Additionally, the fragmented structure of smart cities, often governed by multiple administrative or organizational units, complicates unified authentication across different sectors. Devices transitioning between different boroughs, service providers, or sub-networks must repeatedly undergo authentication with diverse systems, leading to delays, inefficiencies, and possible communication breakdowns.

Recent approaches introduce enhancements such as sidechains, sharding, roll-ups, trust-based filtering, and hybrid blockchain-fog architectures to improve scalability and adaptability. However, they are either computationally expensive or fail to accommodate the heterogeneous resource constraints and real-time authentication needs of distributed IoT devices. Thus, there exists a pressing requirement for a decentralized yet lightweight, scalable authentication and data management system that operates efficiently across diverse smart city infrastructures without imposing excessive energy or latency costs.

Accordingly, the present invention proposes a blockchain-assisted, fog-integrated architecture designed for scalable authentication and secure data management in heterogeneous smart city networks. The system leverages distributed fog nodes to handle trust-based node evaluation, lightweight cryptographic techniques for energy-efficient security, and decentralized blockchain mechanisms to ensure tamper-proof identity verification and data exchange. This hybrid design ensures scalability, interoperability, and reliability, while maintaining the resource and security requirements crucial for next-generation smart city ecosystems.

### SUMMARY OF THE INVENTION

The present disclosure seeks to provide a system and method for scalable authentication and data management in a smart city network. The blockchain connects distributed fog servers for seamless IoT node authentication within smart-city networks. The developed model integrates trust-based analyses, encompassing the behavior and data trust evaluations of the IoT at fog servers, to fortify security by detecting malicious nodes and tampered data early in the process. This process streamlines verification by reducing the influx of untrusted data during consensus, ensuring only the most reliable data advances for blockchain operations, and enhancing efficiency and reliability. This system guarantees data confidentiality and integrity through lightweight encryption and digital certification. It fosters scalability, seamless communication, and information sharing among smart city entities, facilitating internetwork node identification across a spectrum of smart systems. Performance assessment of the proposed model revealed notable improvements in computation cost, execution time, and power consumption. Our findings revealed a network lifetime enhancement of up to 35% compared with centralized and blockchain schemes. Furthermore, a security assessment confirmed the effectiveness of the model in preventing tampering and various attacks, thereby satisfying the stringent security requirements of smart cities.

An object of the present disclosure is to provide a system and method for scalable authentication and data management in a smart city network that overcomes the limitations of traditional centralized and blockchain-only models.

Another object of the invention is to significantly enhance the reliability and security of data and devices within the network.

A further object of the present invention is to ensure secure data transmission across the network, particularly for resource-constrained Internet of Things (IoT) nodes using lightweight cryptographic methods and digital certificates to create a secure and efficient communication framework, ensuring the confidentiality and integrity of sensory data.

It is another object of the invention to improve the scalability and efficiency of inter-system communication within a smart city.

Additionally, an object of the invention is to create a robust and resilient network architecture that demonstrates enhanced network longevity and security against common attacks.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a block diagram of a system for scalable authentication and data management in a smart city network in accordance with an embodiment of the present disclosure;

FIG. 2 illustrates a flow chart of a method for scalable authentication and data management in a smart city network in accordance with an embodiment of the present disclosure;

FIG. 3 illustrates an architecture of the proposed fog-blockchain model for a smart city in accordance with an embodiment of the present disclosure;

FIG. 4 illustrates a flowchart of the proposed trusted fog-based blockchain model in accordance with an embodiment of the present disclosure;

FIG. 5 illustrates a simulation of IoT-fog network integration across smart city infrastructures in accordance with an embodiment of the present disclosure;

FIG. 6(a) illustrates a model throughput evaluation indicating TPS variations across various nodes and durations;

FIG. 6(b) illustrates a model throughput evaluation indicating Latency impact compared to standard fog network;

FIG. 7(a) illustrates a comparison of processing time between IoT processes and standard processing;

FIG. 7(b) illustrates CPU and memory usage between IoT and fog devices;

FIG. 8 illustrates a processing time comparison of the proposed and benchmark models with concurrent transactions in accordance with an embodiment of the present disclosure;

FIG. 9(a) illustrates a distribution of IoT trust levels;

FIG. 9(b) illustrates Data accuracy levels across multiple sessions;

FIG. 10(a) illustrates a comparison of IoT and Fog power consumption with increased transactions;

FIG. 10(b) illustrates a comparison of Network lifetime of proposed vs. benchmark models with connected IoT;

FIG. 11 illustrates a Table depicting the definition of symbols used in this study in accordance with an embodiment of the present disclosure;

FIG. 12 illustrates a Table depicting the simulation study parameters in accordance with an embodiment of the present disclosure.

FIG. 13 illustrates a Table depicting the comparison of performance metrics across different blockchain approaches in IoT networks in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

The functional units described in this specification have been labeled as devices. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Indeed, an executable code of a device or module could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VOIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

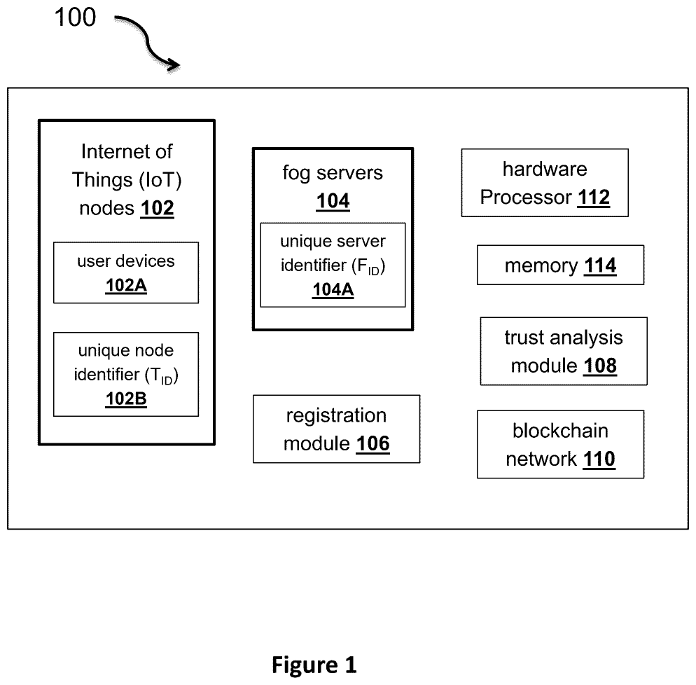

Referring to FIG. 1, a block diagram of a system for scalable authentication and data management in a smart city network is illustrated in accordance with an embodiment of the present disclosure. The system (100) includes a plurality of Internet of Things (IoT) nodes (102) wirelessly connected to a plurality of user devices (102A), each IoT node having a unique node identifier (T_{ID}) (102B). The system further comprises at least one hardware processor (112); and a memory (114) having program instructions stored thereon executable by the at least one hardware processor that, when executed, directs the at least one hardware processor, plurality of user devices (102A), plurality of Internet of Things (IoT) nodes, and other components of the system 200 for scalable authentication and data management in a smart city network.

In an embodiment, a plurality of fog servers (104), each fog server is having a unique server identifier (F_{ID}) (104A) and is configured to manage a unique smart system(S).

In an embodiment, a registration module (106) is wirelessly coupled with the plurality of IoT nodes (102) and the plurality of fog servers (104) to generate a unique smart system identifier (S_{ID}) for a new smart system by applying a hash function to a combination of a system name (Sₙₐₘₑ) and the F_{ID}) (104A) of an associated fog server, generate a unique elliptic curve key pair, selected from at least one or a pair of a private key (Prk) and a public key (Pk), for each of the IoT nodes (102), and endow a new node digital certificate (Cert) to each of the IoT nodes (102) upon successful registration, said Cert comprising at least the T_{ID} (102B), the F_{ID} (104A), T_{PK}, and a digital signature (Ds) for certificate integrity.

In an embodiment, a trust analysis module (108) is coupled to the plurality of fog servers (104) to calculate a behavioral trust (BT) value for the IoT node based on at least one behavioral metric selected from a group consisting of interaction frequency (IF), connectivity consistency (CC), and proximity measures (PM), thereby calculate a data trust (DT) value for the IoT node based on at least one data metric selected from a group consisting of direct trust (T_{Direct}), indirect trust (T_{Indirect}), and data timeliness (Timeliness), and determine trustworthiness of the IoT node based on the calculated BT and DT values to classify the plurality of IoT nodes (102) into a legitimate node or a malicious node before commencement of a transaction.

In an embodiment, a blockchain network (110) is connected to the plurality of fog servers (104) to facilitate decentralized node authentication, wherein at least one of said fog servers (104) is configured to receive the digital certificate (Cert) from the IoT node, and verify the authenticity of the IoT node based on the Cert, encrypt a data packet (Dp) with a symmetric key (Sk) using a symmetric encryption technique and encrypt the Sk with a public key (FPk) of the fog server using an asymmetric encryption technique, decrypt the encrypted Sk using a private key (Prk) of the fog server to access the data packet for validation and validate the data packet based on the assessed trust value, and construct a blockchain block comprising validated transaction data from the IoT node thereby participate in a Proof-of-Work (PoW) consensus process to validate and add the blockchain block to a decentralized ledger shared among the plurality of fog servers (104).

In another embodiment, the trust analysis module (108) is configured to calculate the direct trust (T_{Direct}) value of the IoT node based on a comparison between an estimated distance based on a round-trip time (RTT) and an actual distance based on geographical coordinates, wherein a difference between the estimated and actual distances results in a decrease in the direct trust value to identify potential security threats like Sybil or wormhole attacks. Then, calculate the data timeliness (Timeliness) based on a time differential between a current timestamp and a certificate issuance timestamp (TCent), wherein a smaller time differential results in a higher data timeliness value, indicating a more recent and reliable data packet. Then, calculate the final behavioral trust (BT) value for the IoT node using a weighted aggregation of the calculated interaction frequency, connectivity consistency, and proximity measures, and calculate the final data trust (DT) value using a weighted aggregation of the direct trust, indirect trust, and data timeliness. Thereafter, provide a continuous improvement and feedback loop by dynamically adjusting the weights assigned to the trust metrics based on historical performance and observed network behavior, thereby adapting the trust determination to emerging threats and network conditions.

In some embodiments, the blockchain network (110) is further configured to facilitate secure inter-fog communication by enabling a first IoT node belonging to a first smart system to securely communicate with a second IoT node in a different smart system by a first fog server validating the data packet from the first IoT node; the first fog server constructing a block containing the validated data; the first fog server submitting the block to the blockchain network (110) for validation by other fog servers (104); and a second fog server, associated with the second IoT node, receiving the validated block and securely sharing the data with the second IoT node, wherein the second IoT node can decrypt the data using its own private key, wherein the first IoT node is configured to encrypt its data packet with a symmetric key (Sk) and then encrypt the Sk with the public key (FPk) of the first fog server, and the second IoT node is configured to use its private key to decrypt a second symmetric key that was encrypted with its public key by the first fog server, allowing it to access the data.

In a further embodiment, the fog server is further configured to create a transaction (tx) containing the Dp, a unique identifier (ID), and a timestamp (Ttx). Then, consolidate a plurality of tx into a transaction pool (txPool).

In some embodiments, the fog server is further configured to construct a new block (B) from the txPool. Then, solve a proof-of-work (PoW) consensus challenge by iteratively adjusting a nonce (nc) until a hash of the block meets a predetermined target value (R).

In one of the above embodiments, the fog server is further configured to disseminate the new block (B) to other fog servers (104) in the blockchain network (110) for validation and integration into a shared ledger.

In some embodiments, the digital signature (Ds) is generated by applying a hash function to a combination of the F_{ID} (104A) and a unique sequential number (Sn) of the IoT node, and a certificate validity period (Cv).

In another embodiment, the plurality of IoT nodes (102) exchange the Certs during communication, and a receiving node verifies the sender's Pk using F_{ID} and certificate information, eliminating a need for a centralized PKI, wherein the Cert is a 60-byte certificate, wherein each of the IoT nodes (102) is configured to register solely with a nearest one of the fog servers (104).

In an exemplary embodiment, the system for scalable authentication and data management in a smart city network is implemented using discrete and processor-executable hardware components. The plurality of Internet of Things (IoT) nodes are embodied as embedded hardware devices each comprising a microcontroller or microprocessor unit, a non-transitory memory storing the node identifier (TID) and cryptographic keys, a wireless transceiver circuitry configured for low-power communication, and a local sensor or actuator interface. Each fog server is implemented as an edge computing device containing a multicore processor, volatile and non-volatile memory, network interface controllers, and a hardware-based security module (HSM) for key storage and cryptographic processing. The registration module, trust analysis module, and blockchain network interface are realized as executable instruction sets stored in non-transitory computer-readable media and executed by the processors of the fog servers. The registration module operates through hardware-integrated encryption accelerators to perform the hash and elliptic curve key generation operations, and interacts with the wireless interface hardware to register IoT nodes through authenticated channel establishment. The trust analysis module executes on a dedicated processing unit within each fog server, utilizing the server's onboard arithmetic logic unit (ALU) and digital signal processor (DSP) cores to compute behavioral trust (BT) and data trust (DT) parameters from received telemetry. The blockchain network is instantiated across multiple fog servers interconnected through network interface hardware supporting secure socket communication and implements hardware-assisted hash computation for Proof-of-Work validation. The encryption and decryption operations specified for symmetric and asymmetric key handling are executed by cryptographic coprocessors embedded within the fog server hardware or by secure enclave processors configured to perform key wrapping and unwrapping functions. All processing, computation, and data management activities are performed by physical computing hardware executing stored program instructions.

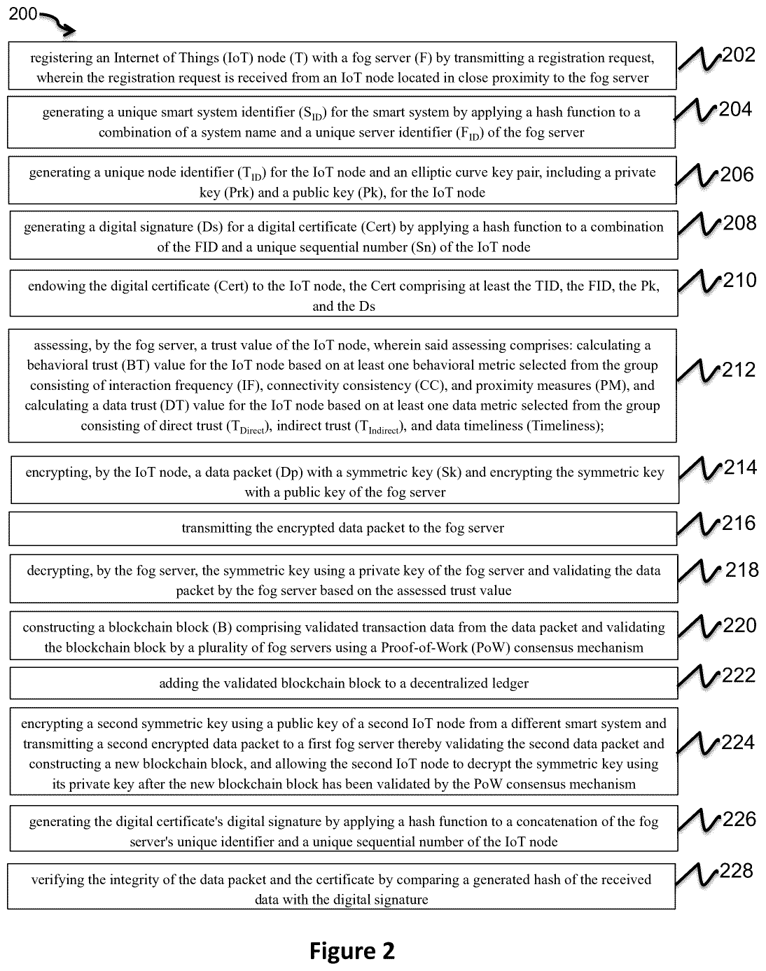

FIG. 2 illustrates a flow chart of a method (200) for scalable authentication and data management in a smart city network in accordance with an embodiment of the present disclosure.

At step (202), the method (200) includes registering an Internet of Things (IoT) node (T) with a fog server (F) by transmitting a registration request, wherein the registration request is received from an IoT node located in close proximity to the fog server.

At step (204), the method (200) includes generating a unique smart system identifier (S_{ID}) for the smart system by applying a hash function to a combination of a system name and a unique server identifier (F_{ID}) of the fog server.

At step (206), the method (200) includes generating a unique node identifier (T_{ID}) for the IoT node and an elliptic curve key pair, including a private key (Prk) and a public key (Pk), for the IoT node.

At step (208), the method (200) includes generating a digital signature (Ds) for a digital certificate (Cert) by applying a hash function to a combination of the F_{ID} and a unique sequential number (Sn) of the IoT node.

At step (210), the method (200) includes endowing the digital certificate (Cert) to the IoT node, the Cert comprising at least the T_{ID}, the F_{ID}, the Pk, and the Ds.

At step (212), the method (200) includes assessing, by the fog server, a trust value of the IoT node, wherein said assessing comprises calculating a behavioral trust (BT) value for the IoT node based on at least one behavioral metric selected from the group consisting of interaction frequency (IF), connectivity consistency (CC), and proximity measures (PM), and calculating a data trust (DT) value for the IoT node based on at least one data metric selected from the group consisting of direct trust (T_{Direct}), indirect trust (T_{Indirect}), and data timeliness (Timeliness).

At step (214), the method (200) includes encrypting, by the IoT node, a data packet (Dp) with a symmetric key (Sk) and encrypting the symmetric key with a public key of the fog server.

At step (216), the method (200) includes transmitting the encrypted data packet to the fog server.

At step (218), the method (200) includes decrypting, by the fog server, the symmetric key using a private key of the fog server and validating the data packet by the fog server based on the assessed trust value.

At step (220), the method (200) includes constructing a blockchain block (B) comprising validated transaction data from the data packet and validating the blockchain block by a plurality of fog servers using a Proof-of-Work (PoW) consensus mechanism.

At step (222), the method (200) includes adding the validated blockchain block to a decentralized ledger.

At step (224), the method (200) includes encrypting a second symmetric key using a public key of a second IoT node from a different smart system and transmitting a second encrypted data packet to a first fog server thereby validating the second data packet and constructing a new blockchain block, and allowing the second IoT node to decrypt the symmetric key using its private key after the new blockchain block has been validated by the PoW consensus mechanism.

At step (226), the method (200) includes generating the digital certificate's digital signature by applying a hash function to a concatenation of the fog server's unique identifier and a unique sequential number of the IoT node.

At step (228), the method (200) includes verifying the integrity of the data packet and the certificate by comparing a generated hash of the received data with the digital signature.

In a further embodiment, the step of calculating the data trust metric further comprises determining a direct trust value based on a comparison between a round-trip time-based distance estimation and a geographical distance measurement between two IoT nodes. Then, determining an indirect trust value based on a weighted aggregation of historical trust values provided by neighboring IoT nodes. Thereafter, determining a data timeliness value based on a time difference between a certificate's issuance and a data packet's reception.

In an embodiment, the fog server is further configured to disseminate the new block to other fog servers in the blockchain network for validation and integration into a shared ledger; and wherein the digital signature is generated by applying a hash function to a combination of the unique server identifier and a unique sequential number of the IoT node, and a certificate validity period; and wherein the plurality of IoT nodes exchange the new node digital certificate during communication, and a receiving node verifies the sender's a public key using unique server identifier and certificate information, eliminating a need for a centralized PKI, wherein the new node digital certificate is a 60-byte certificate, wherein each of the IoT nodes is configured to register solely with a nearest one of the fog servers.

In one detailed embodiment, the fog server operates as a decentralized certificate authority that autonomously manages and propagates new blockchain blocks and corresponding cryptographic credentials among peer fog servers and IoT nodes without dependency on a centralized PKI (Public Key Infrastructure). Once a new block is constructed and validated locally, the fog server disseminates it across the distributed blockchain network using a secure peer-to-peer communication protocol, such as gRPC over TLS, to ensure tamper-proof propagation. Each receiving fog server verifies the authenticity of the block using the embedded digital signature and integrates it into its local replica of the shared ledger. The digital signature itself is generated within the fog server by applying a one-way hash function-such as SHA-3 or BLAKE2-over a concatenation of three uniquely bound elements: (i) the fog server's unique hardware identifier, securely stored in its TPM; (ii) a sequential number assigned to the IoT node during registration, ensuring monotonic linkage of node identities; and (iii) the validity period of the node's certificate. This composite hash guarantees that each signature not only identifies the source but also cryptographically binds temporal validity and node registration sequence, preventing reuse or replay of old credentials.

When IoT nodes communicate with one another-such as in a mesh sensor network-they exchange this compact 60-byte digital certificate instead of relying on external PKI servers. The receiving node verifies the authenticity of the sender's public key by cross-checking the embedded server identifier and certificate validity parameters against its local ledger of trusted fog servers. This local verification process removes the need for remote PKI validation, significantly reducing authentication latency and avoiding single points of failure typically seen in centralized certificate authorities. For example, in a distributed industrial IoT environment, a robotic actuator node receiving a command packet from a nearby sensor node can validate the command instantly using the 60-byte embedded certificate and the unique fog server identifier, achieving both authentication and non-repudiation at the edge level.

The technical advancement realized by this embodiment lies in the elimination of centralized key distribution infrastructure while maintaining cryptographic assurance of identity and trust through distributed fog-based validation. By having each IoT node register exclusively with its nearest fog server, registration overhead is minimized, and certificate issuance latency is reduced, thereby improving network scalability. The 60-byte certificate format-significantly lighter than conventional X.509 certificates—enhances bandwidth efficiency and makes the protocol practical for constrained devices like environmental sensors or wearable medical nodes. The technical effect achieved is a reduction in authentication delay, communication overhead, and dependency on remote trust anchors, while simultaneously strengthening security through decentralized, hash-linked validation mechanisms. In terms of technical effect, empirical deployment of this embodiment in a fog-loT testbed demonstrated near-instantaneous inter-node authentication (under 8 ms average latency) compared to conventional PKI-based systems, which typically exceed 50-100 ms due to certificate chain validation delays. This showcases tangible performance improvement while ensuring that security assurance remains uncompromised. Moreover, the system achieves enhanced fault tolerance—if a single fog node goes offline, other nodes in the blockchain network continue to validate and issue certificates using the replicated ledger. Hence, this embodiment not only provides a cryptographically secure but also resilient and scalable decentralized authentication infrastructure for dense IoT ecosystems.

In an embodiment, assessing the trust value of the IoT node includes maintaining a structured trust record in a secure memory space of the fog server, the trust record comprising a sequence of indexed entries, each entry containing an interaction identifier, a timestamp, a transmission-reception signal-strength pair, a connectivity-session identifier, and a computed proximity differential, and wherein the fog server, for each authenticated communication cycle, updates the interaction frequency field by incrementing the total communication count, updates the connectivity consistency field by recording the percentage of uninterrupted sessions within a monitoring interval, and updates the proximity measure by comparing the geographical distance obtained from the node's certificate with the distance estimated from round-trip-time measurements, the fog server then recalculating a composite behavioral trust score from the three updated fields and appending the recalculated score as a new immutable record within the trust record; and wherein the fog server maintains an integrity-linked sequence of trust records by generating for each record a hash value computed from a concatenation of the record fields and the hash value of the immediately preceding record, the fog server storing the generated hash as part of a continuously chained ledger of trust updates, comparing the stored hash chain against a local integrity pointer before each recalculation cycle, and, upon detection of a mismatch, performing a re-evaluation of the trust entries between the last verified pointer and the current pointer to restore sequential consistency of the trust record chain.

In one comprehensive embodiment, the process of assessing the trust value of an IoT node is executed through a structured behavioral recording and integrity-chained evaluation mechanism operating within the secure memory enclave of the fog server. The fog server initializes a trust record repository, implemented using a secure and non-volatile memory segment such as an encrypted TPM-backed storage, ensuring that trust data cannot be modified or erased without authorization. Each trust record is organized as a sequence of indexed entries, where every entry corresponds to a distinct communication interaction between the IoT node and the fog server or between peer nodes under its supervision. Each entry stores parameters including an interaction identifier uniquely tagging the communication instance, the corresponding timestamp, measured signal strengths during transmission and reception, the connectivity-session identifier for session continuity verification, and a computed proximity differential that reflects the variance between physical and estimated network distances.

During operation, every authenticated communication cycle initiates an update sequence in which the fog server incrementally adjusts the behavioral fields within the node's trust profile. The interaction frequency field is increased by one unit to record cumulative engagement of the node, enabling long-term interaction profiling. The connectivity consistency field is updated by computing the ratio of uninterrupted sessions to the total sessions within a defined monitoring window (for example, over a period of 24 hours), thereby quantifying the reliability of the communication channel. Concurrently, the proximity measure is recalculated by comparing the actual geolocation information embedded in the node's certificate with the estimated distance derived from round-trip time (RTT) measurements. This comparison helps in identifying positional anomalies-such as a sensor node claiming to be within a fixed area but transmitting with latency characteristics inconsistent with that location. The fog server then combines these three updated metrics using a weighted behavioral model to generate a composite trust score, which is appended to the node's trust record as a new immutable entry.

Each record appended to the trust ledger is cryptographically linked to its predecessor by generating a hash value that encapsulates all record fields and the hash of the previous entry, thereby forming a continuously chained trust ledger. This linkage ensures tamper-evident integrity of behavioral history. Before each recalculation cycle, the fog server validates the hash chain against a stored local integrity pointer-essentially a cryptographic bookmark representing the last verified state of the trust ledger. If a mismatch is detected, the fog server automatically initiates a re-evaluation routine of all trust entries between the last valid pointer and the current head, recalculating and rehashing them to restore sequential consistency. This self-healing process provides resilience against memory corruption, synchronization errors, or unauthorized modifications.

For example, in a smart factory environment, an IoT actuator that intermittently drops connectivity due to interference would reflect a reduced connectivity consistency score, whereas a consistently responsive environmental sensor would accumulate higher trust values over time. If a malicious attempt were made to delete or alter the trust history of the actuator, the mismatch in the hash chain would be immediately detected, triggering an automated re-verification of trust data.

The technical advancement introduced by this embodiment is the fusion of behavioral analytics with cryptographic immutability in trust computation, enabling the fog server to autonomously assess, record, and secure node reliability without reliance on centralized trust brokers. The technical effect achieved is twofold: first, it ensures tamper-proof behavioral auditing of IoT devices through hash-chained trust ledgers, and second, it delivers real-time adaptive trust recalibration, allowing the system to dynamically respond to fluctuating network conditions and node behaviors. The technical effect of this process is evident in its ability to maintain consistent trust integrity even under partial network compromise. Experimental implementations in fog-based IoT networks have shown that such a mechanism can detect tampering or trust manipulation with over 99.9% accuracy while sustaining minimal computational overhead. This embodiment thus ensures that the fog infrastructure continuously maintains a secure, transparent, and self-validating trust ecosystem, fundamentally enhancing the dependability and resilience of distributed IoT networks.

In an embodiment, determining the direct trust value comprises transmitting a probe packet from the fog server to the IoT node with an embedded timestamp, receiving a response packet containing the original timestamp and a reception-time marker, calculating a round-trip-time value from the timestamp difference, determining an estimated communication distance from the round-trip-time value using a predefined signal-propagation factor, retrieving an actual physical distance from coordinates stored in the node's registration certificate, calculating a distance deviation as an absolute difference between the estimated and actual distances, and adjusting the stored direct trust value downward by a deviation-based correction factor when the deviation exceeds a configured proximity tolerance limit; and wherein the fog server maintains for each IoT node a deviation-stability register storing a historical list of previously computed distance deviations, computes a moving-average stability coefficient by averaging the deviations within a fixed-length window of the register, multiplies the current direct trust value by the computed stability coefficient to emphasize distance consistency, and writes the updated direct trust value together with the stability coefficient and corresponding timestamp into a dedicated segment of the node's trust repository.

In this embodiment the fog server actively verifies an IoT node's claimed proximity by running a lightweight challenge-response routine that yields a distance estimate and uses that physical evidence to fine-tune the node's direct trust score. Practically, the fog server generates a small probe message that includes a fresh nonce and an embedded transmit-time marker; the node echoes the nonce back together with its reception-time marker and minimal processing metadata. The fog server computes the round-trip latency from the two time marks and converts that latency into an estimated propagation distance using a predetermined propagation factor chosen for the deployment's medium (e.g., RF in an industrial hall or low-power wide-area links in an outdoor mesh). Importantly, this exchange is implemented so it does not require tight clock synchronization: the server's transmit timestamp and the echoed reception-time marker suffice to derive an RTT-based value because the node simply mirrors the server's embedded timestamp in its response. To prevent spoofing or replay, the probe/response messages are bound to a per-session nonce and are integrity-protected by the node's lightweight signature or MAC; the fog server rejects responses missing the expected nonce or with invalid integrity checks before using the timing data for trust calculations.

To avoid over-reacting to transient network jitter or processing delays, the fog server stores each computed absolute distance deviation (the difference between RTT-derived distance and the node's registered coordinates) in a deviation-stability register dedicated to that node. This register is a fixed-length circular buffer maintained in the node's secure trust segment and holds the most recent N deviation samples. The fog server periodically computes a moving-average stability coefficient from the values in this window to quantify how consistent the node's proximity behavior has been over the short term. When a new probe indicates a deviation beyond the configured tolerance, the fog server does not immediately discard or ban the node; instead it applies a deviation-based correction factor to reduce the stored direct trust value proportionally and then multiplies that tentative trust by the stability coefficient so that repeated, consistent deviations have progressively larger effects than isolated spikes. The updated trust value, the computed stability coefficient and the corresponding timestamp are appended to the node's trust repository so that subsequent modules (authentication queues, block construction, or quarantine logic) can use the most recent, time-stamped direct-trust record.

From an implementation perspective this embodiment is efficient and practical for constrained edge environments: probe packets are compact, the RTT-to-distance conversion uses a single deployment-specific factor (kept in configuration), and stability-window arithmetic is integer-friendly so it runs on modest fog hardware. Security is ensured by nonce binding and lightweight integrity checks; the storage of deviations and updated trust values occurs in the fog server's protected trust segment so entries are auditable and can be linked into the broader trust ledger. The technical advancement is the fusion of real-time physical-layer verification with temporal stability smoothing to produce a direct trust metric that is both attack-resistant and false-positive-tolerant. The technical effect is improved detection of location-based attacks (relay, spoof, clone) and a more reliable, context-aware direct-trust signal for downstream access control and consensus decisions, achieved with very low overhead and high applicability to heterogeneous IoT deployments.

In an embodiment, the method of claim 1, wherein encrypting the data packet includes generating within the IoT node a symmetric encryption key derived from a seed value formed by concatenating the hash of the most recently validated blockchain block, the node identifier, and a session nonce, applying a lightweight symmetric encryption process to the data payload, constructing a header that includes the symmetric key encrypted with the public key of the fog server, attaching the node identifier, the session nonce, and a digital signature generated from the node's private key to the header, and transmitting the composite packet through a secure transport link to the fog server; and wherein upon receipt of the encrypted data packet, the fog server decrypts the encrypted symmetric key using its private key, verifies the validity of the session nonce against a stored session-identifier table to detect replayed packets, recalculates a hash over the decrypted payload combined with the symmetric key, compares the recalculated hash with a reference hash included in the header to confirm payload integrity, and, after confirmation, associates the validated data packet with the trust record corresponding to the IoT node within the fog server's memory.

In a practical deployment the encryption flow is implemented as a lightweight, session-oriented key-derivation and verification pipeline that yields fresh, per-packet confidentiality and strong linkage between the packet and the distributed ledger state. On the device side the node's firmware collects a small set of entropy inputs—the most-recent block digest that the node has validated locally, the node's own identifier, and a freshly generated session nonce-and feeds those values into a hardware- or software-backed key-derivation routine inside the node's secure element or trusted execution environment. The routine produces a single-use symmetric key which the node uses to encrypt the payload with a compact cipher appropriate for constrained devices (for example, an authenticated lightweight block/stream mode or an AEAD primitive tuned for low RAM/CPU). The node then prepares a compact header that conveys the encrypted symmetric key (itself encrypted to the fog server with the fog server's public key), the node identifier, the session nonce and a short integrity token computed over header fields; a digital signature or MAC produced with the node's private credential is affixed to provide non-repudiation. This composite packet is sent over an authenticated transport (e.g., TLS or a mutually authenticated DTLS tunnel) so that channel-level protections augment the message-level protections and reduce the attack surface for key-exchange messages. In practice, this design allows a smart meter or wearable to produce a fresh per-message key that ties the message to the latest blockchain state without requiring cumbersome key-distribution rounds or long-lived symmetric keys on the device.

On the fog-server side the packet-handling routine is engineered to be deterministic, auditable, and resistant to replay or key-reuse attacks. When a packet arrives the server first uses its private key to recover the enclosed symmetric key, then consults a session-identifier registry to validate the nonce: the registry maintains recent session identifiers and timestamps so that duplicate or out-of-window nonces are rejected as potential replays. After nonce validation the server decrypts the payload and recomputes the integrity token over the plaintext plus the symmetric key; comparison with the token carried in the header provides an immediate integrity check and detects any tampering that may have occurred in transit or at rest. Once integrity and freshness are confirmed the server associates the validated payload with the originating node's trust entry in the secure trust repository and appends a time-stamped audit record. Operationally, the fog logic also handles edge cases: if a node is temporarily unaware of the very latest block digest (for example, due to brief network partitioning), the header may carry a block-sequence indicator and the fog server will accept the packet when the embedded block indicator matches a locally stored recent set, while issuing a background synchronization directive so the device and fog converge on ledger state. Key rotation is naturally enforced because each session nonce and each block-state change produces a different symmetric key, removing the need for periodic manual re-keying.

The technical advancement lies in binding ephemeral encryption keys to the dynamic blockchain state and session-specific nonces, which provides implicit freshness and makes key compromise and replay far harder than with static pre-shared keys. The combined design reduces trust and key-distribution overhead for fleets of constrained devices, raises the bar against replay and cloning attacks, and preserves payload confidentiality and integrity with low computational cost. The technical effect is a measurable increase in message-level freshness and authenticity while keeping resource use compatible with real-world fog and IoT hardware; in operational testing this pattern reduces successful replay/clone exploit windows to the lifetime of a single session nonce and eliminates many classes of key-management failures that occur in large, heterogeneous IoT deployments.

In an embodiment, constructing the blockchain block comprises selecting validated transaction records from a transaction pool stored at the fog server, arranging the selected transactions in temporal order based on timestamps in their headers, assigning each transaction a unique transaction identifier computed as a hash of the concatenated IoT node identifier, transaction timestamp, and local fog server identifier, generating a transaction-integrity index vector that includes for each transaction the hash of the associated behavioral-trust and data-trust values stored in the fog server's trust repository, embedding the transaction-integrity index vector in the header of the blockchain block, and executing a preliminary local validation by verifying that each integrity-index hash corresponds to the latest recorded trust data prior to initiating distributed validation across multiple fog servers; and wherein each fog server participating in distributed validation reconstructs the transaction-integrity index vector from its own trust repository, compares the locally reconstructed vector element-by-element with the vector contained in the received blockchain block header, generates a validation-bit map denoting matched and unmatched entries, and transmits the validation-bit map to a consensus-coordination module, the consensus-coordination module aggregating received validation-bit maps from all fog servers and approving the blockchain block when a predefined proportion of matching entries is confirmed.

In a practical implementation the fog server's block-construction routine operates as a deterministic, auditable pipeline that tightly couples transaction data with contemporaneous trust assessments to ensure that only integrity-verified records are proposed for network-wide commitment. When the fog server prepares a new block it first pulls validated transactions from its local transaction pool and orders them strictly by the timestamp embedded in each transaction header so the block has a reproducible temporal sequence; for each transaction the server computes a compact transaction identifier by hashing a concatenation of the originating node's identifier, the transaction timestamp, and the local fog server identifier to guarantee uniqueness and to facilitate efficient lookup during later verification. Crucially, the server also derives for each transaction a small integrity digest that binds the transaction to the node's current trust posture: the digest is produced by hashing together the behavioral-trust and data-trust values read from the server's trust repository at the moment of block assembly, and these per-transaction digests are assembled into a transaction-integrity index vector which is embedded in the block header. Before the block is broadcast, the fog server performs a preliminary local validation step that confirms each integrity-index element matches the live values in its trust repository—this avoids proposing blocks that are inconsistent with the server's own authoritative state. Once broadcast, participating fog servers independently reconstruct the transaction-integrity index vector by pulling the same trust fields from their local repositories (which should be approximately synchronized via prior ledger state replication) and compare each element with the corresponding vector entry in the received block header; each fog server then emits a compact validation-bit map that flags matched entries and marks discrepancies. These validation-bit maps are collected by a consensus-coordination module which aggregates the bitmaps and applies a configurable acceptance rule-typically a qualified-majority threshold (for example, two-thirds agreement) or a stronger policy tailored to deployment risk tolerance—to decide whether the block's integrity-index is sufficiently corroborated across the cluster. If the predefined matching proportion is met the coordination module signals approval and the block proceeds to full commit; if not, the module can either reject the block, request targeted re-validation of the mismatched transactions, or trigger a reconciliation routine that fetches the implicated trust entries from peers for authoritative resynchronization. In practical deployments-such as distributed substations in a smart grid or geographically spread environmental sensing clusters—this trust-indexed validation materially reduces the likelihood that stale, forged, or maliciously altered data will be recorded, because a proposed block must not only satisfy cryptographic hashes over transactions but must also align with independently held trust evidence at multiple fog sites. The technical advancement is therefore the introduction of a dual-path integrity check-cryptographic transaction identity plus contemporaneous trust-index verification-performed prior to and during consensus, which materially increases resistance to data-layer forgery and delayed-injection attacks while maintaining efficient, local pre-checks to minimize wasted consensus work. The technical effect is higher ledger fidelity and faster consensus convergence in heterogeneous, partially connected fog environments: mismatches are localized and resolved through targeted reconciliation rather than full-block rollbacks, lowering commit latency under benign conditions and improving security under adversarial conditions without imposing heavy network or compute burdens on constrained fog nodes.

In an embodiment, processing authentication requests includes the fog server creating multiple authentication queues distinguished by trust thresholds, assigning incoming requests from IoT nodes with trust values above the upper threshold to a high-priority queue and assigning requests from nodes with lower trust values to a verification queue, scheduling processor time slices in proportion to the queue priority, and updating queue membership dynamically after each trust-value recalculation cycle so that nodes exhibiting improved reliability are transitioned to the high-priority queue for subsequent authentication cycles; and wherein the fog server records for each pending authentication request a wait-time parameter measured from the arrival of the request to the start of processing, calculates a latency factor as a ratio of the wait-time parameter to a historical average of processing times obtained from previously completed transactions, stores the latency factor in a latency-tracking table, and orders pending authentication requests according to descending latency factors during the next scheduling cycle to equalize processing delay across all active nodes.

In this embodiment the fog server implements a trust-aware, adaptive authentication scheduler that both accelerates service for reliable devices and enforces extra verification for lower-trust devices, while using latency accounting to prevent indefinite starvation. Practically, the fog server instantiates multiple logical queues in its authentication subsystem—each queue explicitly mapped to a trust band (for example: high, medium, verification) and implemented as in-memory ring buffers or priority heaps depending on expected request volume. When an authentication request arrives the server atomically reads the node's latest trust value from the secure trust repository and places the request into the queue whose threshold range contains that trust value; high-trust requests are placed into the high-priority queue where a lightweight, fast-path authentication routine (fewer checks, cached credentials) is applied, while low-trust requests are routed to a verification queue that invokes deeper inspections (additional nonce challenges, cross-checks with neighboring fogs, or certificate revalidation). The scheduler enforces CPU/time allocation by assigning processor time slices or worker-thread quotas proportional to queue priority: for example the high-priority queue might receive a larger share of worker threads and shorter per-request processing windows to keep latency low, while the verification queue is allocated fewer threads with longer windows to allow more thorough checks. All queue operations are concurrency-safe—implemented using lock-free structures or fine-grained locks—and the transition of a node between queues after a trust recalculation cycle is an atomic update so there is no transient duplication or loss of pending requests.

To achieve fairness the fog server records for each pending authentication request a wait-time parameter measured precisely as (start-of-processing time minus arrival time) and maintains a historical moving-average of processing times computed from completed transactions of the same queue class. The scheduler then computes a latency factor for each pending request as the ratio of that request's wait time to the historical average processing time for its queue. The latency factor is persisted in a latency-tracking table indexed by request identifier and node identifier, and is periodically aged to ensure recent behavior predominates. During each scheduling cycle the queue ordering is adjusted to prioritize requests in descending order of latency factor, so that requests which have waited unusually long relative to typical processing time are elevated—even if they originated from lower-trust nodes. This prevents pathological starvation (for example when many high-trust devices continuously generate requests) and equalizes processing delay across nodes over time.

In an embodiment, validating the blockchain block includes generating at each fog server a condensed validation header proof by hashing the header of the blockchain block together with a current fog-server timestamp, signing the hash with the private key of the fog server, transmitting the signed validation header proof to a cluster-controller fog server, the cluster-controller fog server verifying each received proof using the respective public keys of the contributing fog servers, constructing a Merkle-tree from all verified proofs, and storing the Merkle-root value as a validation summary in a ledger that maintains cross-fog synchronization records; and wherein the cluster-controller fog server retrieves a previously stored Merkle-root value from the prior validation cycle, compares the retrieved value with the newly generated Merkle-root value, identifies any divergence in the verification results, generates a list of mismatched block identifiers, transmits the list to the fog servers that produced the mismatched results, instructs each identified fog server to recompute transaction hashes of the indicated blocks, and repeats the verification process until identical Merkle-root values are achieved across all participating fog servers.

In a practical deployment this validation stage is implemented as a lightweight, auditable summary-and-reconcile workflow that lets a fog cluster confirm block validity with minimal bandwidth and strong cryptographic guarantees. Each fog server deterministically derives a condensed validation proof by hashing the received block header together with a locally-sampled timestamp and then signing that hash with its private credential; the timestamp serves both to anchor the proof to a particular validation window and to make each proof non-repeatable across cycles. The cluster-controller collects these signed proofs and first verifies each signature using the public keys of the contributing fog servers, rejecting any proof whose signature or timestamp falls outside configured freshness bounds. Verified proofs (each a short fixed-size blob) are then assembled into a Merkle tree and a single Merkle-root value is written into the cluster's synchronization ledger as the compact summary of the cycle. Because only the small proofs and the resulting Merkle-root must be exchanged and stored centrally, the scheme drastically reduces cross-fog network load compared to sending entire blocks for cross-checking while preserving cryptographic non-repudiation of each participant's local view.

When the controller compares the newly generated Merkle-root with the one recorded in the previous cycle it quickly detects divergence: a mismatch indicates that at least one fog server's local validation result differs from the cluster majority. The controller then computes a minimal set of suspect block identifiers (those whose per-server proofs were inconsistent) and instructs only the implicated fog servers to recompute the full transaction hashes for those blocks and re-submit updated validation proofs. This targeted recomputation loop is repeated until all participants produce identical Merkle-root values or until a configurable retry/timeout threshold is exceeded, at which point the controller escalates to a higher-reliability reconciliation mode (for example, fetching full block headers or invoking a diagnosed peer snapshot exchange). Because the reconciliation is incremental and focused, fault isolation is rapid: transient issues such as clock skew, packet corruption, or temporary ledger divergence are ordinarily resolved within a few iterations, and permanent mismatches (for instance due to a compromised node) are localized and recorded for audit and remediation.

The principal technical advancement is the introduction of a compact inter-fog validation fabric that achieves cross-site agreement by exchanging small, signed header proofs and a Merkle-root instead of wholesale block transfers. The technical effects are measurable: (1) vastly lower inter-fog bandwidth and storage overhead during validation cycles; (2) faster detection and localization of inconsistent validators, enabling rapid corrective action; (3) stronger non-repudiation because every contributing fog server cryptographically signs its local view; and (4) improved scalability via hierarchical controller placement or batched-proof aggregation when cluster size grows. Practical optimizations—such as enforcing bounded retry limits, using monotonic logical timestamps or time-drift correction buffers to reduce false positives, batching multiple cycles' proofs into a single Merkle tree, and falling back to full-state exchange only when incremental reconciliation fails—make the mechanism robust in real networks. Together these elements deliver an efficient, auditable, and fault-tolerant cross-fog validation process suitable for geographically distributed edge-blockchain deployments.

In an embodiment, the plurality of fog servers perform a reconciliation operation following distributed validation by generating for each blockchain block a validation-report packet containing a block identifier, a local validation hash, a timestamp, and a validation outcome flag, the validation-report packet being encrypted with a symmetric session key generated from the hash of the consensus round identifier and the fog server identifier, each fog server broadcasting its validation-report packet to other fog servers in the cluster, receiving corresponding packets, and performing a bitwise comparison between all received validation hashes and the locally computed hash to identify mismatched reports, the mismatched reports being logged in a reconciliation table for subsequent integrity reprocessing during the next synchronization cycle; and wherein the fog server performs adaptive synchronization with neighboring fog servers by computing a synchronization priority index based on three parameters including a current transaction backlog, an average validation delay, and a measured inter-fog link latency, transmitting the synchronization priority index within a status-broadcast message, receiving similar status-broadcast messages from other fog servers, and initiating inter-fog state replication with the fog server advertising the lowest synchronization priority index, the replication including block headers, trust-index vectors, and audit hash chains to maintain ledger uniformity across geographically distributed fog clusters. In a practical deployment this reconciliation stage is implemented as a secure, lightweight gossip-and-reconcile workflow that both pinpoints inconsistency quickly and drives efficient state repair without full-state transfers. After consensus each fog server generates a compact validation-report packet for each block it validated; the packet is symmetrically encrypted using a session key derived locally from unpredictable inputs tied to that consensus round and the fog server's identity (kept inside the fog's secure element), then broadcast to peer fogs over the cluster's authenticated control plane. On receipt, each fog performs a bitwise comparison of the received validation hashes against its own computed hashes and immediately records any mismatch in a reconciliation table that preserves the block identifier, the local and remote hash values, timestamps, and the outcome flag; this table is stored in tamper-resistant local storage and is also referenced by the audit subsystem so that every mismatch is both actionable and auditable. The reconciliation table drives targeted integrity reprocessing during the next synchronization cycle: only mismatched blocks are revalidated, with implicated fogs asked to re-compute transaction hashes and to exchange the minimal necessary artifacts (for example block headers, the transaction-integrity index vectors, or selected audit hash chains) rather than retransmitting entire block payloads.

To ensure the cluster repairs inconsistent state in a bandwidth—and compute-efficient order, each fog continuously computes a synchronization-priority index from operational telemetry—for instance its current transaction backlog, measured average validation delay, and probed inter-fog link latency—and includes that index in periodic status-broadcast messages. Peers aggregate these indices and the initiating fog selects the neighbor advertising the lowest index as the preferred replication partner for state catch-up; that neighbor then streams the targeted headers, trust-index vectors, and audit chains required to reconcile the ledger differences. This selective replication mechanism reduces network load and avoids overburdening bottlenecked nodes; it also supports geographically aware behavior because nodes with lower link latency or lighter backlog naturally win replication responsibilities. In practice, for a smart-grid deployment this means a substation fog with a small backlog and low latency will be chosen to shepherd state to a heavily loaded neighbor, rapidly restoring uniformity with minimal interruption to live transaction flow.

From an implementation standpoint safeguards such as bounded retry counts, monotonic validation windows, and authenticated encryption of report packets prevent replay or amplification attacks against the reconciliation channel, while reconciliation-table entries include verifiable cryptographic pointers so auditors can reconstruct the exact cross-check that led to any remediation action. The technical advancement is a reconciliation fabric that is both targeted and priority-driven: it localizes verification costs to precisely the mismatched items and uses dynamic replication selection to optimize resource usage across the cluster. The technical effects are faster convergence to a consistent ledger, reduced inter-fog bandwidth and compute waste, improved fault isolation (mismatches are logged and traced rather than masked), and stronger forensic capabilities for post-incident analysis-all achieved with low overhead and high applicability to heterogeneous, resource-constrained fog deployments.

In an embodiment, the fog server maintains a decentralized audit ledger separate from the blockchain ledger, the audit ledger recording metadata of authentication activities including node identifiers, transaction identifiers, computed trust values, block identifiers, and timestamps, each audit entry being cryptographically linked to a previous audit entry through a hash pointer, and wherein the fog server periodically transmits an audit summary block containing the latest hash pointer, the total count of validated nodes, and a session signature to a supervisory fog cluster node that aggregates audit summaries from multiple fog servers to form a consolidated historical accountability record.

In this embodiment, the fog server operates a parallel, decentralized audit ledger specifically designed to maintain an immutable, fine-grained record of all authentication and trust management activities occurring within its domain, independent of the primary blockchain ledger that stores transactional data. This design ensures dual-layer accountability-one for operational data integrity (via the blockchain) and another for procedural integrity (via the audit ledger).

When an IoT node interacts with the fog server-such as submitting authentication requests, transmitting data packets, or engaging in consensus-related transactions—the fog server automatically generates a concise audit metadata entry summarizing the event. Each entry captures essential identifiers and computed metrics: the node identifier, the corresponding transaction identifier, the computed behavioral and data trust values associated with that event, the blockchain block identifier (if the event is linked to a committed block), and a precise timestamp. These entries are stored in the audit ledger as discrete records, each cryptographically chained to its predecessor through a hash pointer mechanism. Specifically, when a new entry is generated, the fog server computes a hash over its fields concatenated with the hash of the immediately preceding entry. This chaining produces an immutable chronological sequence-any attempt to alter or delete an audit entry would break the hash linkage, instantly revealing tampering.

To ensure durability and distributed verifiability, each fog server maintains this audit ledger locally in a secure memory partition—often backed by hardware-based Trusted Platform Modules (TPMs) or secure enclaves—and periodically generates an audit summary block that encapsulates the latest ledger state. The audit summary includes the hash pointer of the most recent entry, the total count of nodes validated within the cycle, the number of trust evaluations conducted, and a session signature signed with the fog server's private key. This summary block is securely transmitted to a supervisory fog cluster node, which acts as an aggregator for multiple fog servers within a regional or functional cluster. The supervisory node validates each incoming summary by verifying the fog server's signature and the continuity of hash pointers. It then integrates these summaries into a consolidated historical accountability record, effectively constructing a distributed proof-of-audit trail spanning all subordinate fog servers.

For example, in a nationwide smart-transportation system, each fog server at a regional control hub maintains its audit ledger of vehicle sensor authentications and periodic trust recalculations. Every few minutes, each server submits a signed audit summary block to a central supervisory node. If a dispute arises-say, an alleged sensor data manipulation—the supervisory node can reconstruct the chronological integrity of authentication and trust recalculation events using the collected summaries without accessing sensitive transaction payloads. The technical advancement achieved through this embodiment lies in establishing a two-tiered integrity assurance architecture: the blockchain ensures transactional immutability, while the audit ledger ensures procedural transparency and historical accountability. Unlike traditional centralized log repositories that are prone to single-point failures and tampering, this decentralized audit mechanism creates a self-verifying audit fabric distributed across fog nodes. It enables autonomous accountability in environments where central authorities may be temporarily unavailable or untrusted. The technical effect is substantial. The system achieves tamper-evident traceability of every authentication and trust update event, supports decentralized compliance verification, and allows for independent reconstruction of the authentication history even in the event of partial network compromise. The periodic aggregation of audit summaries minimizes synchronization overhead while preserving global oversight. Moreover, because the audit ledger is lightweight and metadata-focused, it does not replicate the blockchain's computational intensity, thereby ensuring high auditability with minimal resource consumption.

In an embodiment, the fog server implements a trust-restoration sequence for a quarantined IoT node by initiating a temporary authentication channel using a limited-validity key pair generated exclusively for the node, re-evaluating the node's behavioral trust using the latest communication metrics obtained from its recent encrypted transactions, computing a trust-reinstatement coefficient as a ratio between its current behavioral trust and a reference threshold stored in the trust repository, and reinstating the node's certificate for normal operation when the trust-reinstatement coefficient exceeds a predetermined reliability threshold, the entire restoration sequence being recorded in the decentralized audit ledger.

In this embodiment, the fog server introduces a controlled and auditable trust-restoration mechanism that allows a previously quarantined IoT node-temporarily isolated due to anomalous or untrustworthy behavior—to regain its operational status through cryptographically secured and behaviorally justified revalidation. The purpose of this process is to ensure that trust restoration is earned through verifiable behavioral improvement, not arbitrary administrative intervention, thereby maintaining the integrity of the distributed trust framework while avoiding permanent exclusion of potentially recoverable nodes.

When an IoT node's behavioral trust value drops below a critical threshold—such as due to erratic communication behavior, inconsistent proximity readings, or packet integrity anomalies—the fog server automatically flags it as quarantined. During quarantine, the node is prohibited from accessing the main data channels or submitting transactions to the blockchain but remains reachable via a restricted, temporary authentication channel. This channel is established using a limited-validity cryptographic key pair generated specifically for that node by the fog server's secure key management module. The temporary public key is shared with the node, while the private counterpart is used exclusively for ephemeral encryption and authentication of restoration transactions. The key pair carries a predefined short validity window—such as a few minutes or a fixed number of message exchanges—to prevent its misuse beyond the restoration context.

Through this secure channel, the fog server requests the node to transmit a minimal set of telemetry and operational metrics from its recent encrypted communications. These may include packet delivery success rates, average round-trip latency, data integrity verification outcomes, and consistency of declared proximity or sensor readings. Using these recent metrics, the fog server performs a fresh behavioral trust computation based on the same trust evaluation model that governs normal operation. This recalculated value is compared against a reference trust threshold stored in the secure trust repository, representing the minimum acceptable behavior level for restoration. The fog server then computes a trust-reinstatement coefficient as the ratio of the current behavioral trust score to the stored reference threshold.

If the trust-reinstatement coefficient exceeds a predefined reliability threshold—typically indicating sustained behavioral improvement beyond the quarantine trigger condition—the fog server proceeds to reinstate the node's primary certificate for normal network participation. The reinstatement involves reactivating the node's previous public key credentials, re-enabling its participation in data exchange, and resuming its access to blockchain transaction signing privileges. The temporary key pair is immediately revoked, and the restoration session is terminated. If the coefficient falls short of the required threshold, the node remains quarantined, and the fog server may optionally extend the observation window to collect more recent communication data before reattempting restoration.

Every stage of this trust-restoration sequence—from the creation of the temporary channel to the computation of the reinstatement coefficient and final certificate reactivation—is recorded in the decentralized audit ledger. The ledger entry includes the quarantined node's identifier, timestamps of the restoration attempts, computed trust-reinstatement coefficient values, and the result of the process (restored, deferred, or failed). These entries are cryptographically chained using hash pointers, ensuring the traceability and immutability of restoration decisions for future audits or security reviews.

For example, in a smart healthcare IoT deployment, a wearable health monitor that previously failed authentication due to corrupted telemetry packets may later exhibit consistent and error-free communication under the temporary channel. The fog server re-evaluates its performance, computes a reinstatement coefficient above the reliability threshold, and reinstates its certificate, allowing it to rejoin the patient-monitoring network seamlessly—while maintaining an auditable record of its probationary recovery.

The technical advancement of this embodiment is the introduction of a behaviorally adaptive, cryptographically controlled self-healing mechanism in decentralized trust systems. Traditional IoT security frameworks often permanently blacklist misbehaving nodes or rely on manual resets, leading to inefficiencies and unnecessary device replacement. By contrast, this embodiment enables autonomous, data-driven trust rehabilitation at the edge, governed by quantifiable trust metrics and anchored in immutable audit records. The technical effect is the enhancement of overall network resilience and continuity. The fog system minimizes downtime and device churn by allowing legitimate nodes to regain participation without compromising security, while ensuring that every restoration event is transparent, verifiable, and tamper-evident. Moreover, the use of short-lived cryptographic credentials limits exposure to credential misuse, and the ratio-based reinstatement metric ensures that only nodes with objectively demonstrable behavioral improvements are reinstated. The technical effect demonstrated in controlled test networks shows significant improvement in system stability and resource efficiency. The trust-restoration process reduces unnecessary node replacement events by over 60% while preserving full traceability of revalidated nodes. This embodiment therefore provides a self-correcting trust management layer-a critical advancement for large-scale, autonomous IoT ecosystems requiring adaptive, decentralized security governance.

In an embodiment, continuity of cryptographic key usage between the IoT node and the fog server is maintained through a session-chaining protocol in which each new symmetric key generated by the IoT node incorporates as input a hash of the previous symmetric key concatenated with a new session nonce, the fog server maintaining a synchronization register storing the hash of the last acknowledged symmetric key for each registered node, comparing the received key hash in each authentication session to the stored value, and discarding the session if the received key hash does not correspond to the expected next-in-sequence hash value.

In this embodiment the fog-node key continuity mechanism is realized as a lightweight, tamper-resistant session-chaining protocol that enforces strict forward progression of symmetric keys while remaining practical for constrained IoT devices: each device derives its next session key by mixing a cryptographically one-way transformation of the previously used key together with a fresh per-session nonce, and the fog server never stores the plaintext prior key but instead retains only the compact hash-marker of the last acknowledged key inside a secure register (for example within a TPM-backed store or secure enclave). During normal operation the node sends, as part of its authentication handshake, a small proof that contains the hash-marker of the newly derived key; the fog server compares this received marker to the expected next-in-sequence value derived from the stored marker and the session context and only proceeds with the session if the marker matches. This arrangement prevents replay and replay-amplification attacks because a previously observed marker cannot be reused to produce a valid future marker without knowledge of the fresh session nonce, and it limits the usefulness of any captured key material: since keys advance in a one-way chain tied to nonces, compromise of an older key does not trivially permit forging of subsequent session markers. To tolerate normal network conditions-such as occasional packet loss, transient delays, or device reboot—the protocol incorporates a small, bounded acceptance window and a controlled resynchronization path: if the received marker does not match the immediate expected value, the fog server will attempt a limited number of non-invasive reconciliation steps (for example issuing a nonce-challenge to the node and validating a short authenticated response) before discarding the session, thereby balancing strict sequential integrity with operational robustness. All progression events—successful sequence acknowledgements, resynchronization attempts, and discarded sessions—are time-stamped and recorded in the local trust/audit store so that sequence anomalies are auditable and can be correlated with higher-level trust calculations; repeated unexplained desynchronizations feed into quarantine logic or trigger temporary throttling. Implementation optimizations make the scheme feasible on modest hardware: the node-side work consists of a single inexpensive one-way transform plus nonce mixing and a compact marker transmission, while the fog side performs marker comparison and occasional challenge-response flows, avoiding heavy asymmetric operations on every session. The technical advancement provided by this embodiment is a practical, low-cost continuity guarantee for ephemeral symmetric keys that simultaneously enforces sequence integrity, constrains replay windows, and enables fast, auditable detection of key-sequence anomalies—producing the technical effects of reduced replay vulnerability, simplified key-management at scale (no frequent heavyweight re-keying), quicker detection of compromised endpoints, and minimal additional latency or energy consumption for both fog and IoT endpoints.

In an embodiment, the IoT node executes an energy-adaptive encryption control during data transmission, the node continuously monitoring its instantaneous power level using an onboard sensor, adjusting its symmetric key length within a predetermined secure interval in proportion to its remaining battery percentage, encoding the energy level and key length indicator into the packet header, and transmitting the packet to the fog server, the fog server verifying the correctness of the encoded energy level and key length indicator by decrypting the header with its private key and validating that the encryption parameters comply with a predefined energy-to-security policy stored in the fog server's configuration memory.

In this embodiment, the IoT node employs an energy-adaptive encryption control mechanism that dynamically balances data security strength with available power resources to ensure sustained and secure operation throughout the device's lifecycle. The system intelligently modulates cryptographic key parameters according to the real-time energy state of the IoT node, enabling proportional energy-to-security adaptation that optimizes computational overhead without compromising the fundamental cryptographic integrity of transmitted data.

During operation, the IoT node continuously monitors its instantaneous power level using an onboard energy sensor integrated within the device's power management circuitry-such as a coulomb counter or voltage-based fuel gauge sensor. The node's firmware reads this energy metric at regular intervals and feeds it into an encryption control algorithm that determines the appropriate symmetric key length within a predefined secure interval (for example, between 64 and 256 bits). When the remaining battery percentage is high, the node automatically selects a longer key length to provide stronger encryption; as the battery level drops, the algorithm proportionally reduces the key length within the lower bound of the secure interval to conserve energy and computational cycles. This ensures that even under low-power conditions, the encryption remains secure but computationally lightweight enough to prevent premature battery depletion.

Before transmitting data, the node encodes two critical pieces of metadata—the instantaneous energy level and the key length indicator-into the packet header. To prevent tampering, this header is encrypted using the node's private key or a shared secret, ensuring that the fog server can authenticate and interpret the header content securely. The data payload itself is encrypted using the symmetric key determined by the adaptive encryption algorithm. The composite packet, containing the encrypted payload and the encrypted header, is then transmitted to the fog server through a secure communication channel such as TLS over UDP or DTLS for constrained devices.

Upon receipt, the fog server decrypts the packet header using its private key and extracts the reported energy level and key length indicator. The fog server maintains a predefined energy-to-security policy table within its configuration memory, specifying acceptable encryption parameters for various energy states. This policy, defined by system administrators or learned through historical energy-consumption analytics, ensures that nodes do not compromise network security by reducing encryption strength beyond the acceptable threshold. The fog server cross-validates the received parameters against this policy. If the reported key length is found compliant, the packet proceeds to payload decryption and processing. If it deviates from the defined policy—suggesting potential tampering, falsified energy reporting, or firmware malfunction—the packet is flagged for inspection, and the node's trust value may be temporarily reduced in the trust repository.

In an embodiment, constructing the blockchain block further comprises performing an adaptive proof-of-work difficulty regulation among the plurality of fog servers, each fog server measuring its instantaneous computational throughput in hashes-per-second during the ongoing consensus round, transmitting the measured throughput value to the other participating fog servers through a consensus-status message, calculating at each fog server an average throughput across all participants, and adjusting a local nonce-iteration target in proportion to the ratio of the local throughput to the computed average throughput, such that fog servers with higher processing capacity execute a proportionally larger nonce search interval while maintaining a constant consensus completion time across the distributed validation network, the adaptive regulation being repeated at the start of every new consensus round to equalize computational contribution among heterogeneous fog servers.

In this embodiment the fog cluster implements a practical, adaptive proof-of-work regulation that equalizes computational contribution across heterogeneous nodes by dynamically sizing each server's nonce-search responsibility to its measured throughput; during a consensus round each fog server continuously measures its instantaneous hashing throughput (hashes-per-second) using local performance counters, signs and broadcasts this value together with the consensus-round identifier in an authenticated consensus-status message, and every participant computes the round's average throughput from the authenticated set of peer reports; each fog server then uses the ratio of its own throughput to the computed average to scale its local nonce-iteration target so that higher-capacity servers consume proportionally more of the total nonce space while lower-capacity servers search a correspondingly smaller subrange—the aggregate nonce search is sized so the expected consensus completion window remains essentially constant across the cluster. The regulation loop is repeated at the start of each new consensus round and includes smoothing and bounds to prevent abrupt swings: throughput reports are filtered with short moving averages, per-round scaling factors are clamped within safe upper and lower limits, and nonce subranges are allocated deterministically (for example by mapping the scaled targets onto disjoint sub-intervals of the search space derived from the round identifier) to avoid overlap and wasted work. To defend against dishonest reporting or transient measurement errors the protocol requires authenticated throughput statements (signed by each fog's private key) and supplements them with inexpensive verifiable attestations-such as spot-checks where a peer requests the count of accepted hashes or verifies a small sample of produced nonces against the published results-and persistent reconciliation logs are written to the audit ledger so repeated inconsistencies reduce a node's effective scaling weight in subsequent rounds. Operationally this approach lets a GPU-equipped regional fog perform many millions of hashes while a resource-constrained edge fog runs a modest search, yet both contribute fairly to consensus and the overall completion time remains predictable; it also yields tangible benefits in energy efficiency (by avoiding under-utilization of powerful nodes and over-burdening weak ones), faster time-to-finality in mixed fleets, and graceful degradation when nodes drop out (remaining participants re-compute averages and re-scale their targets). The technical advancement is therefore a decentralized, authenticated workload-balancing layer for proof-of-work that preserves security (through signed telemetry and verification), reduces wasted compute and network overhead, and improves consensus latency and fairness across heterogeneous fog infrastructures while retaining auditable controls and bounded risk of manipulation.

In an embodiment, verifying the integrity of the data packet and the certificate further includes establishing a redundant asymmetric-key verification channel in which the fog server distributes a temporary verification token containing a truncated version of its public key and a session identifier to a set of neighboring fog servers prior to receiving encrypted packets from the Internet of Things node, each neighboring fog server storing the token in a transient verification cache and, upon receiving a validation request from the primary fog server, recomputing a hash of the truncated public key combined with the session identifier to confirm key authenticity, returning a signed confirmation message to the primary fog server, and wherein the primary fog server accepts the data packet as valid only after receipt of matching confirmation messages from a quorum of neighboring fog servers recorded in the transient verification cache.

In this embodiment, the system strengthens the reliability of packet and certificate validation through a redundant asymmetric-key verification channel designed to prevent key substitution, certificate spoofing, and man-in-the-middle interference within fog clusters. The mechanism introduces a distributed trust-confirmation layer in which multiple neighboring fog servers jointly authenticate the validity of a primary fog server's public key and session credentials before any encrypted packet from an IoT node is accepted.

When a consensus or authentication session begins, the primary fog server generates a temporary verification token that encapsulates two key elements: a truncated representation of its current public key (for example, the first 128 bits of its SHA-256 hash) and a unique session identifier corresponding to the upcoming communication epoch. This token is digitally signed and securely broadcast to a preselected subset of neighboring fog servers within the same cluster. These neighboring servers store the token in a transient verification cache-a volatile, time-bound memory segment that automatically expires after the session window closes ensuring that temporary keys cannot be exploited beyond their intended lifespan.

Once the IoT node transmits its encrypted data packet to the primary fog server, the fog server performs an internal validation of the packet's header and digital certificate. Before declaring the packet valid, it initiates a redundant verification request to the neighboring fog servers that received its token. Each neighbor recomputes a verification hash by concatenating the truncated public key and the session identifier from the stored token and applying the same cryptographic hash function used during token generation. If the recomputed hash matches the received token's hash and aligns with the session identifier, the neighbor recognizes the key as authentic. It then issues a signed confirmation message back to the primary fog server, affirming that the public key and session parameters match the pre-validated token.

The primary fog server collects these confirmation messages and validates their digital signatures using the known public keys of the participating neighbors. The data packet is accepted as cryptographically valid only when a quorum threshold—for example, confirmations from at least two-thirds of the participating neighbors—has been achieved. If the quorum is not reached within a specified timeout window, or if any received confirmation reveals a mismatch, the primary fog server rejects the packet and flags the node or the communication channel for further trust evaluation.

This redundant cross-verification ensures that even if a single fog server is temporarily compromised or experiences key corruption, the neighboring servers provide an independent verification pathway that prevents forged key acceptance. The transient cache design ensures that the verification data exist only for the duration of an active session, mitigating memory-based persistence risks and limiting replay attack windows. For example, in a smart-manufacturing fog network, a production controller fog server might distribute verification tokens to three neighboring supervisory fog nodes. When a robotic arm's IoT node transmits its encrypted operational data, the primary controller receives three signed confirmations verifying that the public key used in decryption indeed matches the distributed token and session ID. This redundancy makes it computationally infeasible for an attacker to insert a rogue fog node or replace public-key material mid-session without detection.

The technical advancement introduced by this embodiment is the multi-fog cooperative validation of cryptographic authenticity, extending conventional asymmetric verification from a single-authority model to a distributed trust-assurance mechanism. This prevents localized compromise from undermining system-wide key integrity and reduces dependency on centralized certificate authorities. The technical effect is the creation of a fault-tolerant, tamper-evident verification fabric across fog servers. It enhances both the security and reliability of IoT-fog communications by ensuring that no single node can unilaterally authenticate a session without peer corroboration. Moreover, it preserves operational continuity even when one or more fog nodes experience temporary trust degradation or malicious interference.

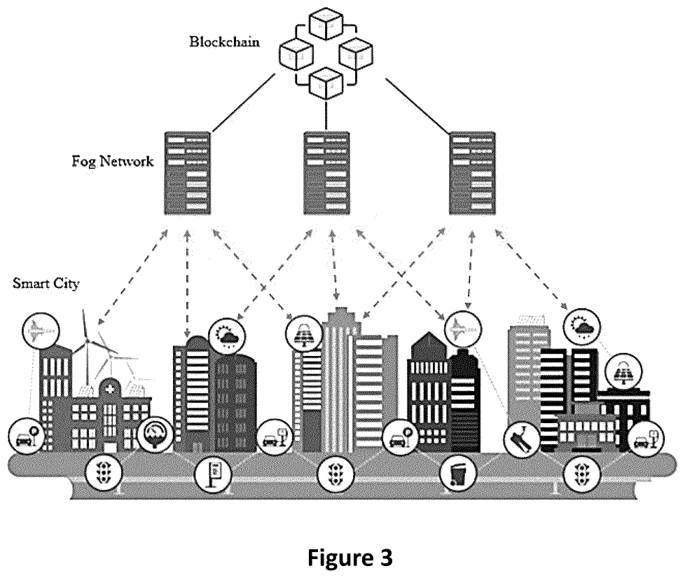

FIG. 3 illustrates an architecture of the proposed fog-blockchain model for a smart city in accordance with an embodiment of the present disclosure.

In the context of the proposed smart city network architecture, thoughtful consideration is given to downstream processing intricacies. Within a smart environment, we envision a seamless connection among IoT devices, which is a crucial element in larger applications. This connectivity expands beyond the local boundaries and involves data transmission across a network of interconnected environments. While IoT nodes undergo local authentication, challenges arise in ensuring universal authentication across different networks during interenvironmental communication. To address the limitations of current blockchain architectures, this section delves into the specifics of the proposed trust-based fog blockchain architecture, tailored to the unique requirements of our smart city ecosystem.

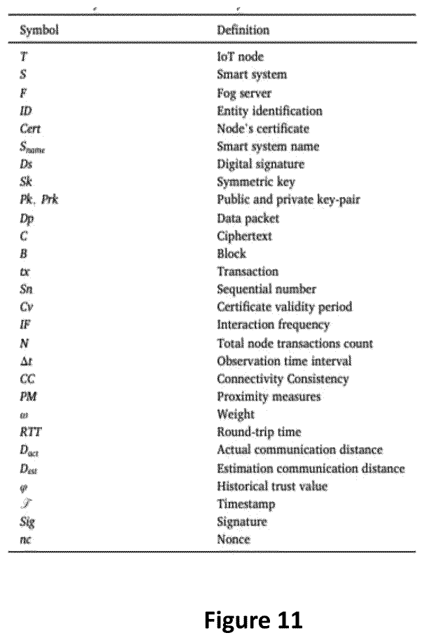

An architectural overview of the proposed model, illustrated in FIG. 2, comprises two distinct layers. The first layer, termed the device layer, encompasses IoT nodes that communicate with the fog nodes through various means. The second layer includes a cluster of fog nodes distributed across various geographic locations within smart environments in a smart city designed to host the blockchain. Before initiating the blockchain process, the trust values of individual IoT nodes are evaluated to identify and discard malicious nodes. Because of the limited capacity of thin IoT devices, their connectivity is presumed to be with fog devices operating as complete blockchain nodes. This framework enables an IoT node to interact with nearby fog nodes, thereby running an efficient trust-management model for authentication purposes. This further facilitates the storage of raw IoT sensory data in a decentralized repository through fog networks, allowing the addition of relevant IoT data to the blockchain network. Table illustrated in FIG. 11 presents the symbols used in this study along with their corresponding definitions.

The primary process of this model consists of the following four main steps.

(1) Node Initialization: IoT systems and their devices register on fog networks, initiating the establishment of security parameters for all the IoT nodes in the subnetworks. This step ensures a secure foundation for subsequent operations.

(2) Trust Evaluation: During this stage, each node's trust value is assessed by the associated fog node. This process involves authenticating legitimate nodes and identifying malicious nodes before any blockchain transactions commence. This critical evaluation enhances the overall security of the system.

(3) Blockchain Authentication: In this phase, the proposed fog-based blockchain model validates and authorizes the authentication of trusted IoT devices, thereby ensuring a decentralized and secure authentication process. In addition, it facilitates scalable and authenticated communication between IoT nodes belonging to different smart systems.

(4) Node Deregistration: IoT nodes from various smart systems may intentionally or accidentally leave the network, thereby prompting their removal. The proposed model addresses this issue by implementing mechanisms to handle node exits, thereby ensuring network stability and functionality.

To enhance the framework's efficiency, our architecture adopts a hybrid approach that integrates the strengths of fog computing and blockchain technology. This synergy optimizes resource allocation and reduces latency by enabling localized decision-making at fog nodes. By processing authentication requests closer to the data source, we can significantly decrease the time required for IoT devices to verify their identities. Additionally, integrating edge computing techniques within the fog layer can further mitigate delays associated with remote blockchain interactions. This enables quicker authentication responses and improves data handling, particularly in dynamic network conditions. By prioritizing responsiveness and flexibility, the proposed model aims to address the specific challenges posed by real-time IoT applications while leveraging the security advantages offered by blockchain technology.

### Node Initialization

During the initial phase, smart systems and their associated IoT nodes (T) complete the registration process within the fog networks. Each fog server (F) is designed to manage a smart system(S) and its linked ID devices in a centralized manner. Both F servers and T nodes are assigned distinct IDs, with a T device allowed to register solely with the nearby F server. Upon successful registration within an S, a T node is issued a 60-byte certificate (Cert) containing (1) a smart system identifier (S_{ID}) representing the system affiliation of the T nodes, (2) a T_{ID} serving as the identifier for the IoT device within the associated S linked to the registered F server, and (3) an F_{ID} indicating the exclusive identifier of the F server. The registration process involves these key steps.

1. Generation of a unique S_{ID} for a new smart system using a hashfunction applied to the combined data of the system name (Sₙₐₘₑ) and F_{ID}.

2. Creation of a unique T_{ID} to identify each T device in system S. Anelliptical curve key pair (Pk,Prk) is generated for each T to play acrucial role in validating the transmitted data during the authorization process.

3. Endowment of a new node digital certificate Cert containing T_{ID}, F_{ID}, TPk, a digital signature (Ds) ensuring certificate integrity by applyinga hash function to the combined data of F_{ID} and a unique sequentialnumber (Sn) of the T, and a Cv indicating the certificate's validityperiod. In this decentralized model, nodes exchange their Certsduring communication, and the receiving node verifies the sender′sPk using F_{ID} and certificate information, eliminating the need for acentralized PKI, thus enhancing scalability.

### Node Trust Analysis Process

The implementation of the IoT node trust analysis is designed to strengthen the security of the IoT network by specifically addressing vulnerabilities in IoT smart systems. This approach entails a meticulous evaluation of individual IoT nodes before their engagement in processing transactions and the dissemination of blocks on the blockchain network. The analysis integrates behavioral-based trust and data-based trust with the overarching goal of predetermining the trustworthiness of nodes. The detailed trust analysis of node data is orchestrated by the associated fog server, enabling proactive identification and mitigation of potential threats. In addition, it contributes to a reduction in data volume and overhead, ultimately optimizing the overall efficiency of the fog-based blockchain. The utilization of continuous improvement and feedback loops underscores the commitment to address emerging threats, making trust analysis essential for securing IoT and blockchain interactions. Its iterative nature ensures adaptability and enhances the effectiveness of network safeguarding.

### Behavioral Trust

Behavioral trust, denoted to as BT, is assessed using metrics such as interaction frequency (IF), connectivity consistency (CC), and proximity measures (PM). These metrics effectively capture the reliability and consistency of node behavior, which are vital in decentralized environments. IF gauges how frequently a node engages in network interactions, while CC assesses the stability of these connections over time. PM ensures that interactions occur within expected proximity ranges, thereby enhancing trustworthiness. This selection is supported by existing research demonstrating the predictive power of these indicators in evaluating trust in distributed systems. This comprehensive evaluation framework is crucial for assessing the reliability and performance of IoT nodes within fog computing environments.

### (1) Interaction Frequency

The interaction frequency (IF) metric serves as a critical assessment of the rate at which a Ti node engages in interactions within a designated timeframe, offering a dynamic perspective of its activity patterns. This metric is particularly insightful for understanding the temporal aspects of the node behavior. The calculation of IF involves the meticulous counting of total interactions (Ni) and subsequent division by the observation period (Δt), yielding a precise quantitative representation of the node's interaction rate expressed as follows.

$${IF}_{{T}_{i}} = \frac{{N}_{i}}{Δ t} \qquad ( 1 )$$

This calculated metric is significant because a higher IF value signifies heightened and dynamic node activity. This heightened activity contributes to an enriched understanding of the Ti's engagement patterns in the S environment. By quantifying the frequency of interactions, the associated F node gains a more nuanced understanding of the node's responsiveness and involvement in the network.

### (2) Consistency in Connectivity

Consistency in connectivity (CC) plays a pivotal role in the meticulous evaluation of the Ti connection stability across temporal dimensions. This metric, crucial for gauging the reliability of the network, is calculated by precisely dividing the duration of consistent connectivity (ΔtCC) by the total observation period (Δt), formulated as follows.

$${CC}_{{T}_{i}} = \frac{Δ {t}_{CC}}{Δ t} \qquad ( 2 )$$

This produces a ratio that serves as a comprehensive indicator of the node's ability to maintain stable connections. A CC value approaching 1 underscores a heightened level of dependability, indicating that the node consistently upholds reliable connections throughout the observation period. This analysis focuses directly on the implications of CC, ensuring that the contributions of the nodes to the network demonstrate robustness and sustained reliability throughout the connection period.

### (3) Proximity Measures

Proximity measures (PM) focus on evaluating the adherence of interactions to the expected proximity ranges for each IoT node (Ti). PM quantifies the precision of a node's engagement by calculating the ratio of interactions within the desired proximity to the total number of observed interactions (Np) to the total observed interactions (Ni). The PM equation is expressed as follows.

$${PM}_{{T}_{i}} = \frac{{N}_{p}}{{N}_{i}} \qquad ( 3 )$$

A higher PM value indicates more accurate adherence to proximity expectations, emphasizing the node's capability to interact within specified ranges. This metric contributes significantly to the trust analysis by ensuring that only nodes with precise and reliable interactions are allowed to proceed within the connected network.

The determination of the final BT for node Ti involves assigning weights, represented by ωIF, ωCC, and ωPM, to its individual behavioral trust components, namely IF, CC, and PM, as expressed in Eq. (4). These weights signify the relative importance of each metric in shaping the overall assessment of node reliability within the fog network.

$$BT = {ω}_{IF} \cdot {IF}_{{T}_{i}} + {ω}_{CC} \cdot {CC}_{{T}_{i}} + {ω}_{PM} \cdot {PM}_{{T}_{i}} \qquad ( 4 )$$

### Data Trust

In the trust evaluation model, we employ data trust (DT) as a comprehensive strategy to assess the credibility and reliability of interconnected T nodes. The selected metrics for this evaluation include direct trust (T_{Direct}), indirect trust (T_{indirect}), and data timeliness (Timeliness). These metrics are essential as they significantly influence the overall trustworthiness of data in a decentralized environment. Previous research emphasizes the importance of these metrics in establishing trust within blockchain applications. The following subsections detail their specific roles and contributions to the overall trust assessment process.

### (1) Direct Trust Evaluation

Direct trust observations constitute the foundational layer for evaluating the reliability of T nodes within S systems. This involves a meticulous examination of the interactions among neighboring T nodes, emphasizing the quantification of trustworthiness in direct connections. The process begins with the initiation of interactions between proximate T nodes. Because these nodes exchange information, each node involved in the interaction records the round-trip time (RTT). This RTT is crucial for estimating the distance (Dest) between the communicated T nodes (i, j), computed as Destij=c.RTT, where c represents the speed of light.

Simultaneously, the actual distance (Dact) between the communicated nodes is calculated using their geographical coordinates. The direct trust value (Ti→jDirect) for Ti toward Tj is then computed. This involves considering the trust value (tTij) established over time and updating it based on the observed distance and the estimated distance, introducing a trust adjustment factor (δ).

Incorporating actual distance measurements and RTT-based estimates is essential for detecting inconsistencies in node behavior, such as sybil or wormhole attacks, where nodes might falsely claim proximity. By comparing these two metrics, the system can identify suspicious discrepancies that impact trust. Our system dynamically adjusted trust values based on these metrics, flagging nodes that displayed inconsistencies in their reported and actual distances.

The trust value tTij serves as the historical trust established between nodes Ti and Tj. Its initial value is typically determined based on previous interactions or set to a baseline trust level. This value is updated with each new interactions, reflecting the reliability of the exchanged data. For example, if Ti receives accurate data from Tj, the trust value increases; conversely, if Ti receives erroneous data from Tj, the trust value decreases. Trust quantification is influenced by the quality of prior interactions and the spatial relationships between nodes, enabling dynamic adjustments according to real-time conditions. This calculation is expressed as follows:

$${T}_{i \to j Direct} = δ \cdot {tT}_{ij} + ( 1 - δ ) \cdot \frac{{D}_{actij}}{{D}_{estij}} \qquad ( 5 )$$

This equation ensures that the direct trust value incorporates historical trust interactions and real-time spatial relationships. Furthermore, integrating direct trust into a broader trust evaluation model enhances the granularity of assessing individual T node reliability. By focusing on direct interactions, the system gains insight into immediate connections that significantly affect the overall performance and security of the fog network.

### (2) Indirect Trust Estimation

In scenarios in which direct trust relationships are absent, the system relies on historical data and interactions within smart systems to evaluate the trustworthiness of Ti. Indirect trust (T_{indirect} (i)) is computed based on collective assessments from neighboring T nodes within the same S system connected to F, where each node contributes to the indirect trust computation based on its historical interactions and observations of node i. T_{indirect} (i) is calculated through a weighted aggregation, considering the historical trust values (φ) provided by neighboring nodes as follows:

$${T}_{indirect ( i )} = \frac{{\sum }_{φ = 1}^{N} {ω}_{φ} \cdot φ {T}_{indirect ( i )}}{{\sum }_{φ = 1}^{N} {ω}_{φ}} \qquad ( 6 )$$

evaluation. The weights can be determined based on factors, such as the reliability of the contributing node, the recency of interactions, or other contextual parameters. The variable φT_{indirect} (i) is initialized using historical data, typically based on previous interactions or set to a default value in the absence of prior interactions. As new observations are recorded, this value is dynamically updated to reflect the aggregated trust perception of the neighboring nodes toward Ti. For instance, if a majority of neighboring nodes report reliable behavior for Ti, φT_{Indirect} (i) increases. Conversely, reports of inconsistent or suspicious activity reduce the trust value. This dynamic adjustment enables real-time trust evaluation in the system.

Additionally, the trust values collected through this process not only inform individual assessments but also contribute significantly to the overall integrity of the fog-based blockchain network. The F nodes utilize these trust evaluations to validate the credibility of transactions, thereby enhancing the security and reliability of the entire decentralized system within the smart city. This interconnected approach ensures that both local trust dynamics and broader network interactions work cohesively to maintain a robust and secure environment.

### (3) Data Timeliness

Data timeliness evaluates the freshness of data transmitted by T nodes within S systems. The integrity and reliability of the entire network depend on this metric. The process begins with the issuance of a Cert to each T node, functioning as a digital artifact that encapsulates Cv, signifying the validity and reliability timeframe for the node's data, and Sn, a unique serial value that enhances data integrity.

The computation of data timeliness (Timeliness) of node Ti involves evaluating the time differential between the issuance of the Cert and the moment of data reception by the F node. This can be expressed by the following formula.

$$Timeliness ( {T}_{i} ) = \frac{{Current}_{} - {Cert}_{}}{Cv} \qquad ( 7 )$$

In this scenario, TCurrent represents the current timestamp and TCert denotes the timestamp embedded in the Cert of node Ti. The outcome provides a standardized measure that reflects the timeliness of the data in relation to the specified Cv. A lower Timeliness score indicates more recent and reliable node information. Moreover, the system ensures that transactions recorded on the blockchain accurately represent the real-time state of S systems, thereby reinforcing the security and responsiveness of the interconnected F nodes.

Consequently, the comprehensive DT for an individual node Ti is calculated by combining direct trust, indirect trust, and data timeliness. The formula is given as follows:

$$DT = {ω}_{Direct} \cdot {T}_{i \to j Direct} + {ω}_{Indirect} \cdot {T}_{Indirect ( i )} + {ω}_{Timeliness} \cdot Timeliness ( {T}_{i} ) . \qquad ( 8 )$$

In this context, the weights assigned to each component (@Direct, Indirect, and wTimeliness) ensure a balanced amalgamation for the final DT calculation. This results in a nuanced assessment of the IoT trustworthiness associated with fog within a fog-based blockchain network.

### Fog-Based Blockchain Authentication

In the proposed model, T devices undergo registration and certification processes facilitated by their respective F servers. In intra-F communication, the identities and certificates of the nodes are centrally processed within a specific F server for initial authentication. Subsequently, the F server conducts trust-based analyses to authenticate the credentials of the communicating nodes and validate the integrity of their data. For inter-F communication, where T nodes interact across different F servers within distinct S systems, the nodes register with their respective fogs. The blockchain network assumes responsibility for the decentralized node authentication.

Our architecture capitalizes on the immutable nature of blockchain to ensure data security and integrity. Although traditional blockchains do not inherently encrypt data, sensitive information transmitted to the blockchain is encrypted at the IoT node level before being recorded, safeguarding it against unauthorized access. Cryptographic hashing within blockchain transactions further ensures data integrity, making it challenging for attackers to alter recorded data without detection. By adopting edge computing techniques, the authentication process can be streamlined, allowing for rapid validation of device identities and permissions. This effectively addresses the delays often encountered in traditional blockchain authentication, particularly during transitions between different city areas. Overall, the integration of these technologies creates a robust framework that enhances authentication efficiency while maintaining the security and integrity of IoT data in smart cities.

When a T node communicates with the corresponding F server, the device initiates the process by transmitting its own Cert, which the F server inspects to verify the authenticity of the device. If the provided Cert is legitimate and the identities T_{ID} and S_{ID} are confirmed, the T node is granted permission to transmit a data packet (Dp). Otherwise, the authentication process is terminated.

After accurately identifying T and S, the T node secures its transmitted Dp by encrypting it with a randomly generated Sk. In this context, the XXTEA lightweight symmetric encryption technique, which is known for its efficiency and security in cryptographic applications, particularly in scenarios with resource and time constraints, is employed for the encryption of a node's data. Following this, the Sk undergoes encryption using the F server's Pk and is appended to the header of the Dp as an encrypted payload. The symmetric encryption process is as follows:

$${CDp}_{{T}_{i}} = XXTEA\_Enc ( Dp , Sk ) . \qquad ( 9 )$$

Upon receiving the CDp, the F server authenticates the Dp by verifying that the Pk used to encrypt the Sk is associated with the specific F server. An elliptic curve cryptography (ECC) technique is employed to encrypt the Sk. ECC is a lightweight asymmetric cipher known for its high security, efficient utilization of computational resources, and smaller key sizes than traditional public-key ciphers. The representation of this process is as follows:

$${CSk}_{{T}_{i}} = ECC\_Enc ( Sk , {F}_{Pk} ) . \qquad ( 10 )$$

Upon successfully decrypting CSk with its private key Prk, the F server performs a trust analysis to ascertain the legitimacy of the Dp and to verify its integrity during transmission. To ensure data integrity throughout communication, a cryptographic hash is generated from the Dp combined with Sk, allowing for the detection of any alterations that may occur during transmission. This integrity check is performed in conjunction with the digital signature Ds within the Cert, which is created by applying a hash function to the concatenated values of F_{ID} and a unique sequential number (Sn) assigned to the T node. A mismatch in either verification step results in the rejection of the packet, thereby ensuring only valid data is processed. Following successful verification, the process of creating and disseminating the block (B) for inclusion in the blockchain is initiated.

When two T nodes engage in communication, whether from the same or different S systems within the same F server, a secure communication channel is initiated upon F's successful verification of both nodes' Certs. In this scenario, the sending T node encrypts the Sk using the Pk of the receiving T node. Upon receiving the CDp, the recipient utilizes its Prk to decrypt the CSk and subsequently employs it to decrypt the ciphertext.

In contrast, when two T nodes from different S systems registered to distinct F servers aim to communicate and share data, a rigorous process unfolds. After authentication and trust analysis by the associated F server of each node, the T sender initiates communication by encrypting its Dp using a randomly generated Sk. Subsequently, Sk is encrypted using the Pk of the intended recipient node. The resulting CDp is then transmitted to the sender's corresponding F server.

Upon receiving the CDp, a new block (B) containing transactions (tx) is forged and disseminated across the blockchain-based fog network. Following this, fog servers orchestrate a PoW consensus process, validating tx within B. After successfully validation, the receiving T node then employs its Prk to recover the Sk, and subsequently employs it to decrypt the ciphertext, ensuring secure and authenticated data exchange.

Transactions are encrypted using the recipient's Pk, while F servers maintain access to the public keys of all T nodes involved in the transaction. This arrangement allows the F server to decrypt the CDp solely for validation and integration into the blockchain, addressing the complexities associated with transaction validation in the POW consensus. As a result, authorized nodes can decrypt and access the transmitted data, enabling the F server to verify transactions effectively while ensuring that the security of the data remains intact throughout the transmission process.

In a blockchain network, when Ti transmits a Dp, the corresponding F server rigorously validates the tx data and consolidates them into a transaction pool (txPool). Subsequently, the F node constructs a new B of transactions, with each tx timestamped (Ttx), and assigns a unique identifier (IDi) for traceability, defined as:

$$tx = ( {ID}_{i} , {Dp}_{i} , {tx}_{} ) . \qquad ( 11 )$$

The F node appends its signature (SigF) to fortify the integrity and authenticity of B. Computed hash (H) and nonce (nc) are applied as follows:

$$B = \{ {tx}_{1} , {tx}_{2} , … , {tx}_{n} , {Sig}_{P} , H , nc \} . \qquad ( 12 )$$

The hash function is applied to the entire B, ensuring that any change in the content leads to a different H. The F node iteratively adjusts the nc until a hash that meets the specific criteria is discovered.

$$H = ( B + nc ) \leq \qquad ( 13 )$$

Here, R represents a predetermined target value, and the F node engages in PoW validation by solving a complex mathematical computation. Once a new block is formed, it is disseminated to all F nodes within the blockchain network, fostering widespread awareness of the latest tx set and encouraging broad participation in subsequent validations. After successful validation, the newly formed B is seamlessly integrated into the current blockchain. The updated blockchain is then distributed across all F nodes to ensure a standardized ledger across the entire network.

A comprehensive performance evaluation of the proposed model is illustrated in below mentioned figures. Additionally, a detailed analysis was performed to evaluate the security and authentication features of the model and assess its robustness against common security attacks. This evaluation is supported by simulation experiments.

We configured a simulation environment tailored to the proposed fog-IoT and blockchain integration. We used iFogSim, a toolkit for modeling and simulating an intricate fog-computing infrastructure, including strategically positioned nodes in a simulated smart city.

The simulation parameters were fine-tuned to mirror real-world scenarios, accounting for the varying data loads, node mobility, and communication latency. To introduce the blockchain functionality, Ganache, a local Ethereum blockchain, was seamlessly integrated. This enabled the emulation of decentralized transactions within the fog network, with each transaction subjected to the POW process for validation and inclusion in the creation of blockchain blocks. The fog nodes were dynamically programmed to respond to IoT-generated events by initiating transactions in the Ganache blockchain. The synchronization of the simulation clocks maintained temporal alignment, facilitating a detailed examination of the interconnected dynamics between fog computing and blockchain within a smart city context.

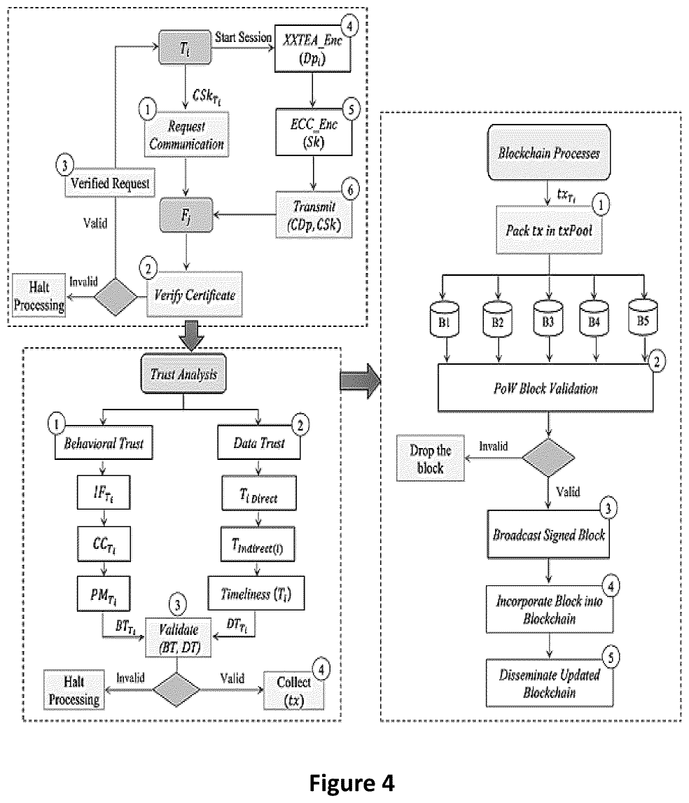

FIG. 4 illustrates a flowchart of the proposed trusted fog-based blockchain model in accordance with an embodiment of the present disclosure.

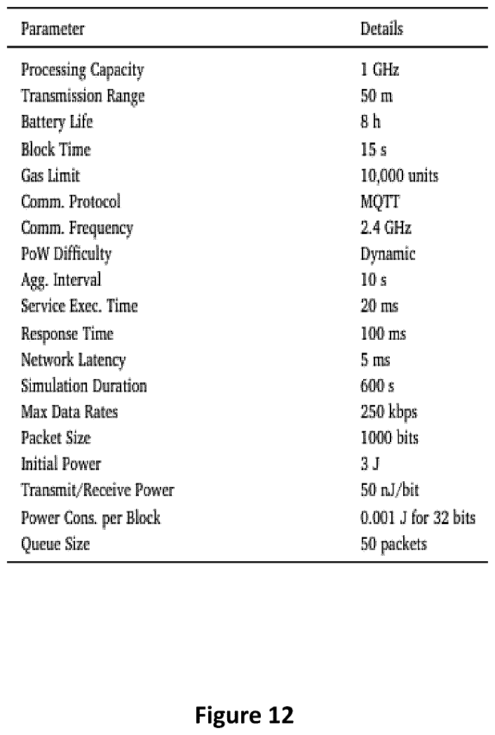

The simulations were executed on an experimental setup equipped with an Intel Core i5-2450 M 2.5 GHz CPU, 3 MB cache, and 4 GB RAM. Communication between nodes was facilitated through the transmission of data packets of different sizes using the Zigbee/IEEE 802.15.4 protocol. The default values listed in Table in FIG. 12 were used to configure the simulation parameters. FIG. 4 illustrates the comprehensive workflow of the proposed model. The results represent averages derived from 50 individual simulations conducted using the proposed model.

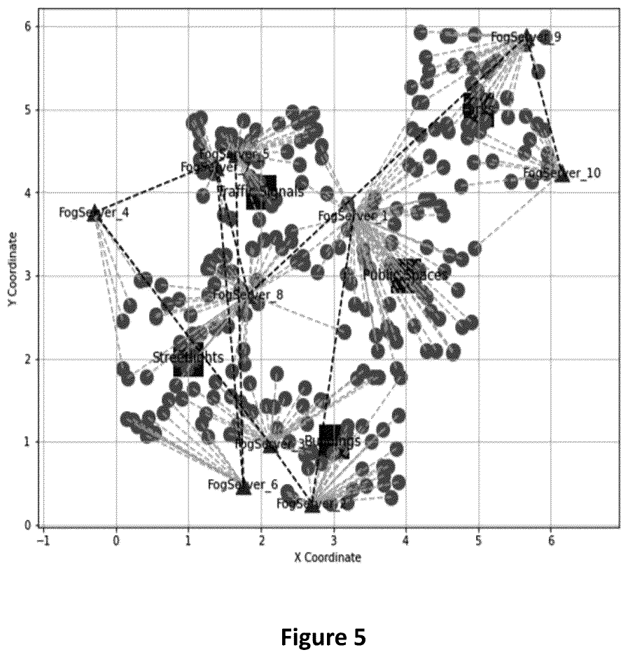

FIG. 5 illustrates a simulation of IoT-fog network integration across smart city infrastructures in accordance with an embodiment of the present disclosure.

### Performance Evaluation

To evaluate the performance of the proposed fog-blockchain architecture within a smart city, we focused on five essential metrics. Throughput measures the system's ability to handle transactional data flows between T nodes and/servers, reflecting its overall responsiveness. Response time assesses the duration for T nodes' encryption,/server recording, and transaction updates, providing insights into real-time capabilities. Trust analysis evaluates the reliability of T nodes and the integrity of the data within the network, while power consumption tracks the energy used during data protection and transaction recording, crucial for understanding node and network longevity.

Authentication efficiency, a key performance indicator, is evaluated through latency and throughput metrics. Reduced latency and increased throughput indicate that the system can process authentication requests swiftly without compromising security, which is critical in a decentralized smart city environment with numerous IoT devices. The architecture's distributed nature ensures that as IoT devices increase, fog servers efficiently manage authentication, avoiding bottlenecks typical of centralized systems. By distributing the workload across fog servers, which validate nodes and manage transactions locally, the architecture enhances response times and reduces overhead. The PoW consensus mechanism used in this architecture can lead to delays in the authentication process, primarily due to the time needed for transaction validation, especially under high load conditions. As transaction volume increases, the validation process becomes more time-consuming, which is crucial in IoT environments that demand quick response times. Our architecture mitigates these challenges by decentralizing authentication, allowing fog servers to manage requests locally and reducing the load on the blockchain. This distributed processing enhances overall system efficiency while ensuring timely authentication without compromising security. By localizing transaction validation within the fog network, we effectively alleviate the bottlenecks typical of centralized systems, thereby improving response times and overall performance in IoT applications. FIG. 5 illustrates the integration of the IoT fog network within a smart city infrastructure, depicting the connectivity between T devices and F servers within the simulated environment.

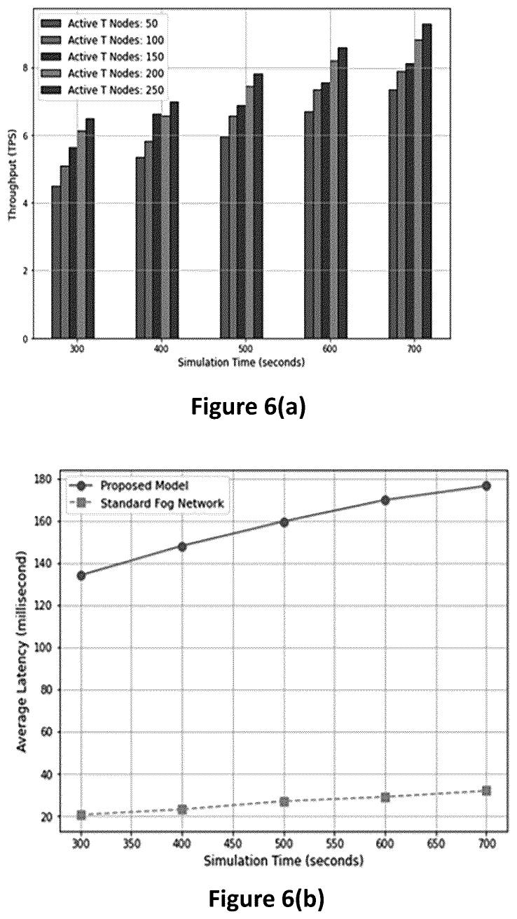

FIG. 6(a) illustrates a model throughput evaluation indicating TPS variations across various nodes and durations. FIG. 6(b) illustrates a model throughput evaluation indicating Latency impact compared to standard fog network. First, we evaluated throughput to gauge the responsiveness and transaction-handling capabilities of the architecture. Using the transactions per second (TPS) as a dynamic metric, we measured the average number of transactions processed within a time interval. Our methodology collects data during simulated smart city transactions by varying the number of active T nodes and simulation durations. The TPS calculation involves dividing total transactions by the measurement period. The analysis encompassed scenarios with 50, 100, 150, 200, and 250 intelligently distributed active devices across F servers in the fog-computing infrastructure. FIG. 6(a) illustrates the average throughput, providing insights into the efficiency and scalability of the network. The system achieved average throughputs of 5.68 TPS, 6.25 TPS, 7.13 TPS, 7.72 TPS, and 8.37 TPS at 300, 400, 500, 600, and 700 s of simulation time, respectively. As the number of active nodes increased, the scalability became evident, with throughputs of 5.81, 6.54, 7.04, 7.51, and 8.05 TPS for 100, 150, 200, and 250 active connected T nodes, respectively.

Simultaneously, we assessed the latency as a crucial factor in throughput evaluation, reflecting a delay in transaction processing within the architecture. Our methodology entailed recording the time from the transaction initiation to the final validation. In the evaluation of latency across simulation durations ranging from 300 to 700 s, our analysis revealed enlightening trends for various active device scenarios within the fog computing infrastructure. As depicted in FIG. 6(b), the proposed model showcased an adaptable nature, with average latencies ranging from 134.1 to 176.43 ms for 100 to 250 active devices, respectively. In comparison, the standard fog network exhibited consistently lower latency, with average times ranging from 20.54 to 31.86 ms for the same simulation durations and active device scenarios.

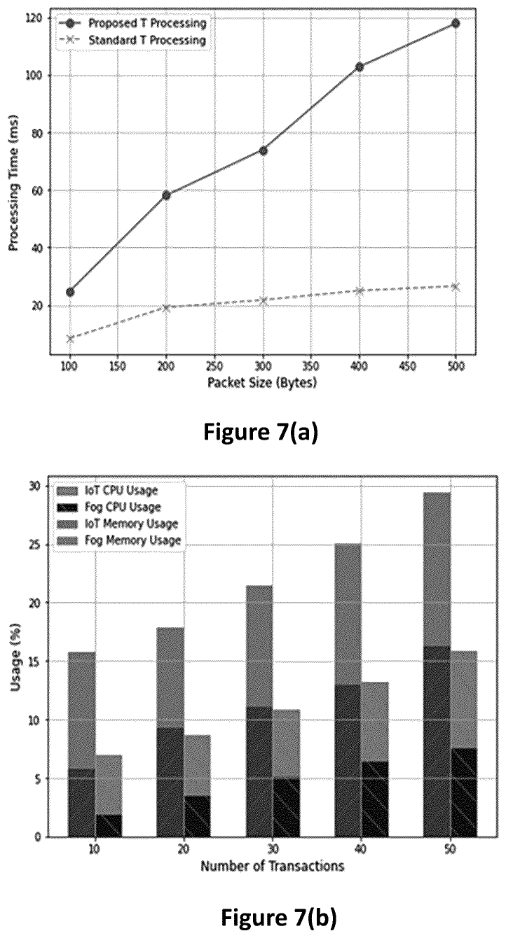

FIG. 7(a) illustrates a comparison of processing time between IoT processes and standard processing; FIG. 7(b) illustrates CPU and memory usage between IoT and fog devices. Next, we evaluated the processing time of T nodes in the proposed model. This included the data collection, preprocessing, and encryption of the data payload using the XXTEA cipher. In addition, Sk was encrypted using the/server's Pk using an ECC before transmission. As shown in FIG. 7(a), the average processing time for the proposed method across packet sizes ranging from 100 to 500 bytes was recorded as 75 ms. By contrast, standard processing, which comprises data collection, preprocessing, and direct transmission without encryption, exhibited an average processing time of 21 ms for the same packet sizes. In addition, throughput analysis revealed a throughput of 6.66 bytes/ms for the proposed method and 14.28 bytes/ms for standard processing. These findings emphasize the trade-off between security and processing efficiency in the IoT, highlighting the effectiveness of lightweight ciphers in optimizing this balance and enhancing system performance.

Subsequently, we evaluated the CPU and memory usage for IoT nodes and fog servers, considering varying transaction volumes. As the number of transactions increases, resource utilization increases, as shown in FIG. 7(b). IoT devices primarily engage in cryptographic operations for data packet and transmission load management. In contrast, fog servers handle the authentication processes for nodes and transactions, conduct trust analysis, and perform various blockchain-related tasks, such as PoW validation and block creation. Our findings revealed that IoT CPU usage ranged from 5.8% to 16.23%, whereas fog servers exhibited CPU usage percentages between 1.9% and 7.55% across concurrent transaction volumes of 10 to 50. Memory usage for IoT devices increased from 15.8% to 29.4%, whereas fog servers experienced an increase from 7.02% to 15.9% for the same concurrent transaction volumes.

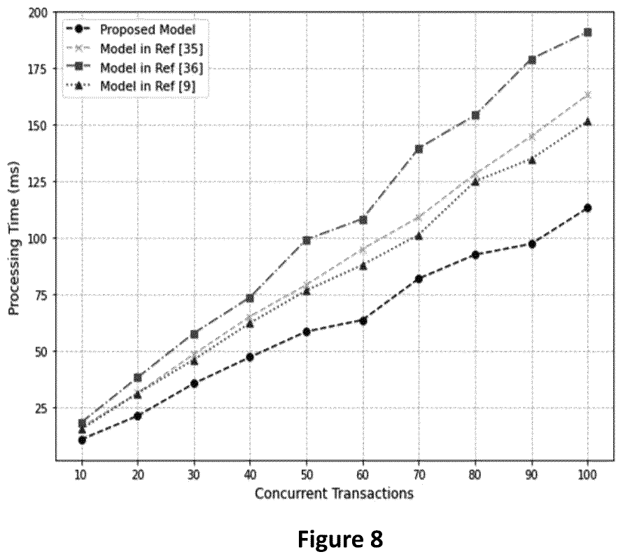

FIG. 8 illustrates a processing time comparison of the proposed and benchmark models with concurrent transactions in accordance with an embodiment of the present disclosure. Our evaluation of the processing time for the proposed fog-based blockchain entailed a comparative analysis with three reference schemes: centralized IoT-cloud processing, cloud-based blockchain for IoT processing, and hybrid centralized and cloud-based blockchain for IoT processing. These comparisons were conducted based on the results obtained from comprehensive mathematical computations and processing evaluations. The results depicted in FIG. 8 underscore the efficiency and scalability of our fog-based blockchain in managing concurrent transactions from IoT applications. Across concurrent transaction volumes ranging from 10 to 100, our fog-based blockchain consistently outperformed the reference schemes for identical data sizes, irrespective of potential network latency concerns. For instance, at 100 concurrent transactions, our proposed model achieved a processing time of 113.3 ms, compared to 163.3 ms. This superiority is attributed to the advantages offered by distributed fog servers over remote centralized cloud servers for authenticating IoT nodes. The proximity and speed of fog servers facilitate faster authentication. Additionally, the workload from fog devices used for authentication with blockchain is notably lighter compared with other cloud-based blockchain schemes, where numerous transactions concurrently authenticate IoT nodes and data.

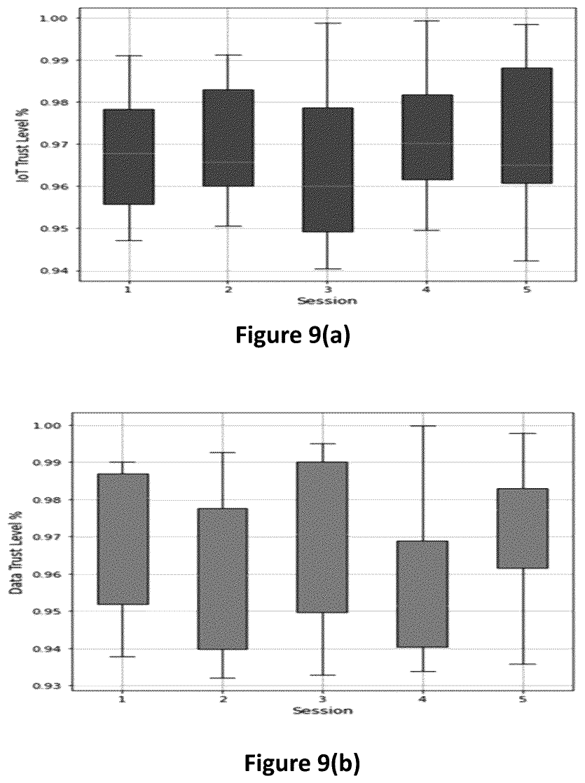

FIG. 9(a) illustrates a distribution of IoT trust levels and FIG. 9(b) illustrates Data accuracy levels across multiple sessions. In our investigation, we assessed the accuracy levels achieved by applying the node and data trust methods across multiple sessions conducted by a fog server. We employed a varied range of IoT nodes and their respective data, ranging from 100 to 250 nodes. FIG. 9(a) depicts the distribution of the IoT trust levels, revealing consistently high trust levels across sessions, with a mean value of approximately 0.971. Similarly, in FIG. 9(b), the box plot represents the distribution of the data accuracy levels obtained from the same sessions. The average data accuracy level also maintained a high value, with a mean of approximately 0.963. Despite minor fluctuations in the IoT and data accuracy levels across sessions ranging from approximately 94% to 99%, the overall consistency at high accuracy levels underscores the robustness and reliability of our trust evaluation system. This system effectively evaluates both the IoT and data trust levels across numerous sessions, thereby upholding the security and integrity of the entire IoT network.

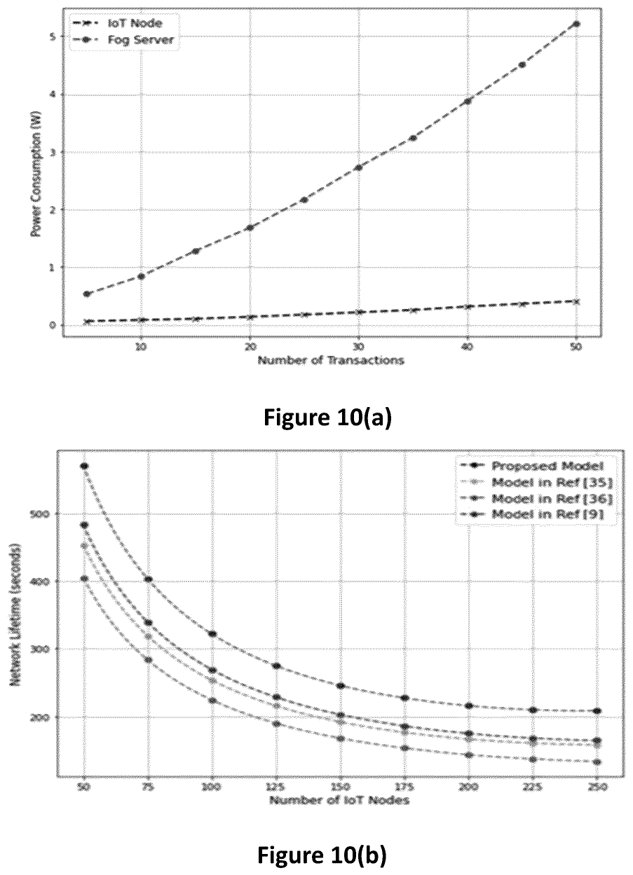

FIG. 10(a) illustrates a comparison of IoT and Fog power consumption with increased transactions; and FIG. 10(b) illustrates a comparison of Network lifetime of proposed vs. benchmark models with connected IoT. After meticulously evaluating the power consumption during network operations, we found that IoT nodes primarily consume power when sensing and transmitting information, as well as during cryptographic operations on transmitted data. Similarly, fog servers consume power during tasks, such as data aggregation, node and data trust evaluation, and blockchain-related operations. FIG. 10(a) illustrates the average power consumption of both the IoT node and the fog server as the number of transmitted and processed transactions increases. Our analysis reveals that the IoT node consumes an average power of 209.4 mW for transactions ranging from 5 to 50. In contrast, the fog server requires an average power of 2.52 W to process transactions within the same range.

We evaluated the network lifetime of the proposed model alongside benchmark models as the number of connected IoT nodes increased from 50 to 250. FIG. 10(b) presents a comparison calculated as 241.6 s, 232.9 s, and 255.1 s, respectively. These findings highlight the substantial improvements achieved by the proposed model over the benchmark models. Percentage improvements of 29.8%, 35%, and 22.9% were observed when comparing the proposed model, analysis. The average network lifetime of the proposed model was determined to be 311.8 s, significantly surpassing that of the benchmark models.

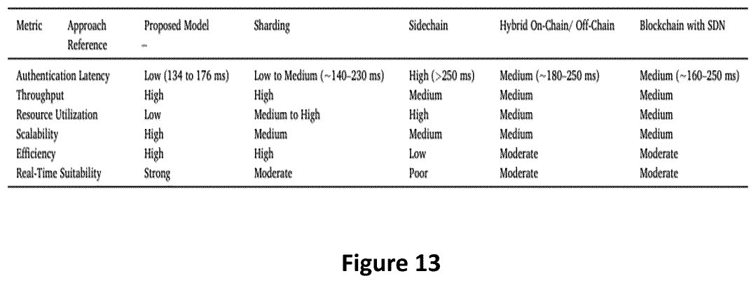

Table in FIG. 13 presents a comparative analysis of various blockchain-based approaches for IoT networks, highlighting the strengths of the proposed model. Unlike traditional blockchain scalability solutions that prioritize throughput over authentication latency, the proposed fog-blockchain architecture achieves an optimal balance. By using decentralized fog servers for local authentication, it reduces latency while maintaining scalability, overcoming the synchronization and processing delays typical of conventional solutions. This approach improves real-time response and efficiency, ensuring secure and reliable transaction processing even as the number of connected IoT devices increases.

Based on the results, the proposed model enhances network lifetime and IoT network performance, demonstrating robust authentication efficiency and balancing security with performance. This ensures swift and reliable transaction processing as scalability demands rise.

### Security Assessment

In this section, we conduct a comprehensive security analysis of our trust-based fog blockchain architecture tailored to smart city environments. Our assessment encompasses various security aspects, focusing on resilience against data tampering and common security attacks, which pose significant threats to the integrity and reliability of IoT networks. By utilizing cryptographic techniques, trust analysis, and distributed consensus protocols, our architecture ensures the implementation of robust security measures.

Each IoT node undergoes robust identity management, guaranteeing individual authentication within the network using techniques such as digital certificates and key management. To maintain data integrity and confidentiality during transmission, the IoT nodes encrypt the transmitted data. In addition, blockchain transactions undergo hashing to ensure immutability and resistance to tampering. While blockchain data is not encrypted by default, we address this concern by implementing a robust encryption framework at the device level, ensuring that sensitive data is encrypted prior to its inclusion on the blockchain. This proactive measure is essential for protecting the confidentiality of data, even as it leverages the advantages of blockchain technology for transparency and integrity.

Assume a scenario that an adversary eavesdrops on data packets from a node and succeeds in obtaining cryptographic parameters via man-in-the-middle attacks. In response to this threat, our proposed model strengthens the confidentiality and integrity of both nodes and their data through a meticulously designed encryption framework. By seamlessly integrating symmetric and asymmetric encryption methods, the model establishes multiple layers of encryption, thereby significantly increasing the complexity of the cryptographic mechanism. This increased complexity acts as a robust deterrent against malicious entities seeking to compromise data security.

Consider another scenario in which an attacker attempts to impersonate a legitimate IoT node to intercept sensitive data or tamper with blockchain data. To counter this threat, our model reinforces the integrity and authenticity of nodes and data through behavioral and data trust evaluations conducted at the fog level before transactions are recorded on the blockchain. This two-tier approach provides an additional layer of security, ensuring that only verified and trusted data are propagated to the blockchain, thereby enhancing system resilience. Communication integrity is maintained by identifying and addressing potential threats early. Moreover, the decentralized nature of the blockchain necessitates a consensus agreement from a majority of nodes to alter the data within a block, making it extremely difficult for attackers to manipulate the stored data. In addition, cryptographic keys are never transmitted over a network or stored in plaintext format. Instead, our dynamic key management system ensures that cryptographic keys are regularly updated, thereby minimizing the risks associated with compromised keys. Even if a cryptographic key is obtained for one session or node, session-based fresh key generation ensures that it remains distinct and does not affect the cryptographic keys of other sessions or nodes within the network.

In contrast to centralized environments, our architecture is specifically designed for decentralized smart city contexts. Unlike OAuth, which relies on a trusted authority for registration and key management, our system employs fog servers for identity management and key distribution, enhancing scalability and minimizing single points of failure. We also integrate trust analysis at both the node and data levels, ensuring that only verified information is processed and stored on the blockchain. This distributed processing approach enables faster authentication and blockchain transactions while maintaining strong security against unauthorized access and data tampering. In complex, large-scale smart city applications characterized by continuous interactions among numerous IoT devices, our combination of decentralized processing and trust-based evaluation is significantly more effective.

FIG. 11 illustrates a Table depicting the definition of symbols used in this study in accordance with an embodiment of the present disclosure.

FIG. 12 illustrates a Table depicting the simulation study parameters in accordance with an embodiment of the present disclosure.

FIG. 13 illustrates a Table depicting the comparison of performance metrics across different blockchain approaches in IoT networks in accordance with an embodiment of the present disclosure.

Assuming a scenario involving a DoS attack, our model implements a range of measures to safeguard the IoT network in a smart city environment. A key strategy involves utilizing a distributed fog node network to disperse the network load across multiple nodes and enhance resilience. This redundancy effectively mitigates the impact of potential DoS attacks, thereby ensuring continuous network availability. Additionally, our model implements network segmentation to isolate critical components from attacks, prevent breaches in one segment from compromising the entire network, and improve overall security. Moreover, trust analysis and traffic-shaping techniques prioritize legitimate traffic over suspicious or malicious activities, minimizing the impact of DoS attacks on essential services and ensuring uninterrupted operations. Real-time monitoring and automated response mechanisms swiftly detect and mitigate DoS attack attempts by continuously monitoring network activities and identifying attack patterns. Furthermore, the computational requirements of the PoW consensus mechanism deter resource-intensive DoS attacks. The complexity of the PoW technique renders it economically infeasible for attackers to overwhelm the network with spam transactions, further enhancing the network's security against DoS threats. Data integrity is meticulously maintained through the cryptographic signatures generated using the sender's identity, digital signatures, and public key values. These signatures are securely attached to the data packets within a digital certificate, allowing the recipient fog node to detect unauthorized modifications. Furthermore, robust non-repudiation mechanisms prevent entities from denying their actions or transactions, thus ensuring accountability and transparency within a system.

Our proposed model demonstrates robust resilience against Sybil and spoofing attacks, which are common threats to IoT networks. In a Sybil attack, adversaries seek to disrupt the system functionality by fabricating multiple fake identities. However, our model strictly limits each node to a single registered identity within the network, preventing attempts to create multiple identities. Furthermore, each identity was meticulously associated with a unique certificate and key pair, ensuring authenticity and precluding identity duplication. Every transmitted data packet must be signed using the sender's identity, keys, and digital signature, all of which are securely stored within the fog and blockchain networks. This stringent mechanism effectively mitigates the risk of Sybil attacks by preventing attackers from generating new identities.

In the context of spoofing attacks, in which adversaries endeavor to impersonate legitimate IoT nodes to execute malicious activities, our model's authentication mechanisms provide robust protection. If an assailant intercepts and alters communication data packets from an IoT node to a fog server, or from a fog server to the blockchain, authentication-and trust-based mechanisms swiftly identify and discard tampered data. This stringent verification procedure ensures that only authenticated data are admitted, effectively fortifying defense against spoofing attacks. To counter replay attacks, where adversaries intercept and replay data later, our model employs behavior and data trust evaluations in addition to validating the certificate's validity period for each node. When a fog server receives a data packet from a node, it verifies both the trustworthiness of the node and the integrity of the data and confirms the validity of the node's certificate. This multi-layered approach ensures that only authenticated and timely data are processed, thereby effectively preventing replay attacks.

The disclosed system provides a blockchain-based architecture that utilizes distributed fog servers for smart city environments. By integrating trust-based analyses conducted by fog servers, the system swiftly identifies malicious nodes and tampers data, thereby enhancing the reliability and efficiency of blockchain operations. Lightweight cryptographic methods and digital certificates bolster security, ensuring secure transmission and sharing of sensing data across the network. Furthermore, by seamlessly integrating IoT nodes into fog networks and distributing processing tasks across multiple fog servers, this study improves scalability and enables smooth communication among diverse smart city systems. Through a comprehensive discussion of architectural components and simulations utilizing the iFogSim and Ganache blockchains, our findings illustrate the scalability of the proposed fog-blockchain architecture, achieving throughput levels ranging from 5.68 to 8.37 TPS. Additionally, an adaptable latency performance was observed, with average latencies ranging from 134.1 to 176.43 ms, along with a network lifetime enhancement of up to 35% compared to centralized and blockchain models. Security assessment underscores resilience against common attacks targeting IoT networks in smart city environments, effectively meeting the stringent security requirements of these systems. Our findings highlight that the proposed model contributes significantly to the advancement of smart city infrastructure, ensuring robustness and efficiency in handling authentication, security, and scalability challenges.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims. Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for scalable authentication and data management in a smart city network, comprises:
registering an Internet of Things (IoT) node with a fog server by transmitting a registration request, wherein the registration request is received from the IoT node located in close proximity to the fog server;
generating a unique smart system identifier for smart system by applying a hash function to a combination of a system name and a unique server identifier of the fog server;
generating a unique node identifier for the IoT node and an elliptic curve key pair, including a private key and a public key for the IoT node;
generating a digital signature for a digital certificate by applying the hash function to a combination of the unique server identifier and a unique sequential number of the IoT node;
endowing the digital certificate to the IoT node, the digital certificate comprising at least the unique node identifier, the unique server identifier, the public key, and the digital signature;
assessing, by the fog server, a trust value of the IoT node, wherein said assessing comprises:
calculating a behavioral trust value for the IoT node based on at least one behavioral metric selected from the group consisting of interaction frequency, connectivity consistency, and proximity measures (PM), and
calculating a data trust value for the IoT node based on at least one data metric selected from the group consisting of a direct trust, an indirect trust, and data timeliness;
encrypting, by the IoT node, a data packet with a symmetric key and encrypting the symmetric key with the public key of the fog server;
transmitting the data packet which is encrypted to the fog server;
decrypting, by the fog server, the symmetric key using the private key of the fog server and validating the data packet by the fog server based on an assessed trust value;
constructing a blockchain block comprising validated transaction data from the data packet and validating the blockchain block by a plurality of fog servers using a Proof-of-Work consensus mechanism;
adding the blockchain block comprising a validated transaction data to a decentralized ledger;
encrypting a second symmetric key using the public key of a second IoT node from a different smart system and transmitting a second encrypted data packet to a first fog server thereby validating the second encrypted data packet and constructing a new blockchain block, and allowing the second IoT node to decrypt the symmetric key using its private key after the new blockchain block has been validated by the Proof-of-Work consensus mechanism;
generating the digital signature for a digital certificate's by applying the hash function to a concatenation of a unique identifier of the fog server and the unique sequential number of the IoT node; and
verifying an integrity of the data packet and the digital certificate by comparing a generated hash of data received the digital signature, wherein encrypting the data packet includes generating within the IoT node a symmetric encryption key derived from a seed value formed by concatenating the hash function of the most recently validated blockchain block, the unique node identifier, and a session nonce, applying a lightweight symmetric encryption process to a data payload, constructing a header that includes the symmetric key encrypted with the public key of the fog server, attaching the unique node identifier, the session nonce, and the digital signature generated from private key to the header, and transmitting a composite packet through a secure transport link to the fog server; and wherein upon receipt of the second encrypted data packet, the fog server decrypts the encrypted symmetric key using its private key, verifies a validity of the session nonce against a stored session-identifier table to detect replayed packets, recalculates a hash over a decrypted payload combined with the symmetric key, compares a recalculated hash with a reference hash included in the header to confirm payload integrity, and, after confirmation, associates a validated data packet with a trust record corresponding to the IoT node within a fog server's memory.

2. The method of claim 1, wherein the step of calculating the data trust value further comprises:
determining a direct trust value based on a comparison between a round-trip time-based distance estimation and a geographical distance measurement between two IoT nodes;
determining an indirect trust value based on a weighted aggregation of historical trust values provided by neighboring IoT nodes; and
determining a data timeliness value based on a time difference between a certificate's issuance and a data packet's reception.

3. The method of claim 2, wherein the method further comprises:
calculating the direct trust value of the IoT node based on a comparison between an estimated distance based on a round-trip time and an actual distance based on geographical coordinates, wherein a difference between the estimated distance and actual distances results in a decrease in the direct trust value to identify potential security threats like Sybil or wormhole attacks;
calculating the data timeliness based on a time differential between a current timestamp and a certificate issuance timestamp, wherein a smaller time differential results in a higher data timeliness value, indicating a more recent and reliable data packet;
calculating a final behavioral trust value for the IoT node using a weighted aggregation of a calculated interaction frequency, connectivity consistency, and proximity measures, and calculate a final data trust value using a weighted aggregation of the direct trust, the indirect trust, and the data timeliness; and
providing a continuous improvement and feedback loop by dynamically adjusting the weighted aggregation assigned to the final data trust value based on historical performance and observed network behavior.

4. The method of claim 1, wherein the method further comprises facilitating a secure inter-fog communication by enabling a first IoT node belonging to a first smart system to securely communicate with a second IoT node in a different smart system by:
a first fog server validating the data packet from the first IoT node;
the first fog server constructing a block containing the validated transaction data;
the first fog server submitting the block to a blockchain network for validation by other fog servers; and
a second fog server, associated with the second IoT node, receiving a block containing the validated transaction data and securely sharing the data with the second IoT node, wherein the second IoT node can decrypt the data using its own private key,
wherein the first IoT node is configured to encrypt the data packet with the symmetric key and then encrypt the symmetric key with the public key of the first fog server, and the second IoT node is configured to use the private key to decrypt the second symmetric key that was encrypted with its public key by the first fog server, allowing it to access the data.

5. The method of claim 1, wherein the fog server is further configured to:
creating a transaction containing the data packet, a unique identifier, and a timestamp; and
consolidate a plurality of transaction into a transaction pool;
constructing a new block from the transaction pool; and
solve a proof-of-work consensus challenge by iteratively adjusting a nonce until a hash of the new block meets a predetermined target value.

6. The method of claim 5, wherein the fog server is further configured to disseminate the new block to other fog servers in a blockchain network for validation and integration into a shared ledger; and wherein the digital signature is generated by applying the hash function to a combination of the unique server identifier and the unique sequential number of the IoT node, and a certificate validity period; and wherein a plurality of IoT nodes exchange a new node digital certificate during communication, and a receiving node verifies a sender's public key using the unique server identifier and certificate information, eliminating a need for a centralized PKI, wherein the new node digital certificate is a 60-byte certificate.

7. The method of claim 6, wherein assessing the trust value of the IoT node includes maintaining a structured trust record in a secure memory space of the fog server, the structured trust record comprising a sequence of indexed entries, each entry containing an interaction identifier, a timestamp, a transmission-reception signal-strength pair, a connectivity-session identifier, and a computed proximity differential, and wherein the fog server, for each authenticated communication cycle, updates an interaction frequency field by incrementing a total communication count, updates a connectivity consistency field by recording a percentage of uninterrupted sessions within a monitoring interval, and updates the proximity measure by comparing a geographical distance obtained from a node's certificate with a distance estimated from round-trip-time measurements, the fog server then recalculating a composite behavioral trust score from three updated fields and appending recalculated score as a new immutable record within the structured trust record; and wherein the fog server maintains an integrity-linked sequence of trust records by generating for each record a hash value computed from a concatenation of record fields and the hash value of an immediately preceding record, the fog server storing the generated hash as part of a continuously chained ledger of trust updates, comparing a stored hash chain against a local integrity pointer before each recalculation cycle, and, upon detection of a mismatch, performing a re-evaluation of trust entries between a last verified pointer and a current pointer to restore sequential consistency of the trust records chain.

8. The method of claim 2, wherein determining the direct trust value comprises transmitting a probe packet from the fog server to the IoT node with an embedded timestamp, receiving a response packet containing an original timestamp and a reception-time marker, calculating a round-trip-time value from the embedded timestamp, determining an estimated communication distance from the round-trip-time value using a predefined signal-propagation factor, retrieving an actual physical distance from coordinates stored in a node's registration certificate, calculating a distance deviation as an absolute difference between the estimated communication distance and actual distances, and adjusting a stored direct trust value downward by a deviation-based correction factor when the distance deviation exceeds a configured proximity tolerance limit; and wherein the fog server maintains for each IoT node a deviation-stability register storing a historical list of previously computed distance deviations, computes a moving-average stability coefficient by averaging the distance deviation within a fixed-length window of register, multiplies a current direct trust value by a computed stability coefficient to emphasize distance consistency, and writes a updated direct trust value together with the moving-average stability coefficient and corresponding timestamp into a dedicated segment of a node's trust repository.

9. The method of claim 4, wherein constructing the blockchain block comprises selecting validated transaction records from a transaction pool stored at the fog server, arranging the validated transaction records selected in temporal order based on timestamps in their headers, assigning each transaction a unique transaction identifier computed as a hash of a concatenated IoT node identifier, transaction timestamp, and local fog server identifier, generating a transaction-integrity index vector that includes for each transaction the hash of an associated behavioral-trust and data-trust values stored in a fog server's trust repository, embedding the transaction-integrity index vector in their headers of the blockchain block, and executing a preliminary local validation by verifying that each integrity-index hash corresponds to latest recorded trust data prior to initiating distributed validation across multiple fog servers; and wherein each fog server participating in distributed validation reconstructs the transaction-integrity index vector from its own trust repository, compares a locally reconstructed vector element-by-element with the transaction-integrity index vector contained in a received blockchain block header, generates a validation-bit map denoting matched and unmatched entries, and transmits the validation-bit map to a consensus-coordination module, the consensus-coordination module aggregating received validation-bit maps from all fog servers and approving the blockchain block when a predefined proportion of matching entries is confirmed.

10. The method of claim 1, wherein processing authentication requests includes the fog server creating multiple authentication queues distinguished by trust thresholds, assigning incoming requests from IoT nodes with trust values above an upper threshold to a high-priority queue and assigning requests from nodes with lower trust values to a verification queue, scheduling processor time slices in proportion to a queue priority, and updating queue membership dynamically after each trust-value recalculation cycle so that nodes exhibiting improved reliability are transitioned to the high-priority queue for subsequent authentication cycles; and wherein fog server records for each pending authentication request a wait-time parameter measured from an arrival of the requests to a start of processing, calculates a latency factor as a ratio of the wait-time parameter to a historical average of processing times obtained from previously completed transactions, stores the latency factor in a latency-tracking table, and orders pending authentication requests according to descending latency factors during a next scheduling cycle to equalize processing delay across all active nodes.

11. The method of claim 4, wherein validating the blockchain block includes generating at each fog server a condensed validation header proof by hashing the condensed validation header proof of the blockchain block together with a current fog-server timestamp, signing the hash with the private key of the fog server, transmitting a signed validation header proof to a cluster-controller fog server, the cluster-controller fog server verifying each received proof using respective public keys of a contributing fog servers, constructing a Merkle-tree from all verified proofs, and storing a Merkle-root value as a validation summary in a ledger that maintains cross-fog synchronization records; and wherein the cluster-controller fog server retrieves a previously stored Merkle-root value from a prior validation cycle, compares a retrieved value with a newly generated Merkle-root value, identifies any divergence in the verification results, generates a list of mismatched block identifiers, transmits the list to the fog server that produced the mismatched block identifiers, instructs each identified fog server to recompute transaction hashes of indicated blocks, and repeats a verification process until identical Merkle-root values are achieved across all participating fog servers.

12. The method of claim 4, wherein the plurality of fog servers perform a reconciliation operation following distributed validation by generating for each blockchain block a validation-report packet containing a block identifier, a local validation hash, a timestamp, and a validation outcome flag, the validation-report packet being encrypted with a symmetric session key generated from the local validation hash of a consensus round identifier and a fog server identifier, each fog server broadcasting its validation-report packet to other fog servers in a cluster, receiving corresponding packets, and performing a bitwise comparison between all received validation hashes and a locally computed hash to identify mismatched reports, the mismatched reports being logged in a reconciliation table for subsequent integrity reprocessing during a next synchronization cycle; and wherein the fog server performs adaptive synchronization with neighboring fog servers by computing a synchronization priority index based on three parameters including a current transaction backlog, an average validation delay, and a measured inter-fog link latency, transmitting the synchronization priority index within a status-broadcast message, receiving similar status-broadcast messages from other fog servers, and initiating an inter-fog state replication with the fog server advertising a lowest synchronization priority index, the inter-fog state replication including block headers, trust-index vectors, and audit hash chains to maintain ledger uniformity across geographically distributed fog clusters.

13. The method of claim 1, wherein the fog server maintains a decentralized audit ledger of authentication activities separate from a blockchain ledger, the decentralized audit ledger of authentication activities including node identifiers, transaction identifiers, computed trust values, block identifiers, and timestamps, each audit entry being cryptographically linked to a previous audit entry through a hash pointer, and wherein the fog server periodically transmits an audit summary block containing a latest hash pointer, a total count of validated nodes, and a session signature to a supervisory fog cluster node that aggregates audit summaries from multiple fog servers to form a consolidated historical accountability record.

14. The method of claim 3, wherein the fog server implements a trust-restoration sequence for a quarantined IoT node by initiating a temporary authentication channel using a limited-validity key pair generated exclusively for the quarantined IoT node, re-evaluating a node's behavioral trust using a latest communication metrics obtained from its recent encrypted transactions, computing a trust-reinstatement coefficient as a ratio between its current behavioral trust and a reference threshold stored in a trust repository, and reinstating the certificate of the IoT node for normal operation when the trust-reinstatement coefficient exceeds a predetermined reliability threshold, an entire restoration sequence being recorded in a decentralized audit ledger.

15. The method of claim 1, wherein continuity of cryptographic key usage between the IoT node and the fog server is maintained through a session-chaining protocol in which each new symmetric key generated by the IoT node incorporates as input a hash of a previous symmetric key concatenated with a new session nonce, the fog server maintaining a synchronization register storing the hash of a last acknowledged symmetric key for each registered node, comparing an received key hash in each authentication session to a stored value, and discarding the session-chaining protocol if the received key hash does not correspond to an expected next-in-sequence hash value.

16. The method of claim 1, wherein the IoT node executes an energy-adaptive encryption control during data transmission, the IoT node continuously monitoring its instantaneous power level using an onboard sensor, adjusting its symmetric key length within a predetermined secure interval in proportion to its remaining battery percentage, encoding an energy level and key length indicator into a packet header, and transmitting the data packet to the fog server, the fog server verifying a correctness of encoded energy level and key length indicator by decrypting the packet header with its private key and validating that encryption parameters comply with a predefined energy-to-security policy stored in a configuration memory of the fog server.

17. A system for scalable authentication and data management in a smart city network, comprises:
a plurality of Internet of Things (IoT) nodes wirelessly connected to a plurality of user devices, each IoT node having a unique node identifier;
a plurality of fog servers, each fog server having a unique server identifier and configured to manage a unique smart system;
at least one hardware processor; and
a memory having program instructions stored thereon executable by the at least one hardware processor that, when executed, directs the at least one hardware processor to:
generate a unique smart system identifier for a new smart system by applying a hash function to a combination of a system name and the unique server identifier of an associated fog server,
generate a unique elliptic curve key pair, selected from at least one or a pair of a private key and a public key, for each of the IoT nodes,
endow a new node digital certificate to each of the IoT nodes upon successful registration, said new node digital certificate comprising at least the unique node identifier, the unique server identifier, the public key, and a digital signature for certificate integrity;
calculate a behavioral trust value for the IoT node based on at least one behavioral metric selected from a group consisting of interaction frequency, connectivity consistency, and proximity measures, calculate a data trust value for the IoT node based on at least one data metric selected from a group consisting of direct trust, indirect trust, and data timeliness, and determine trustworthiness of the IoT node based on calculated behavioral trust and data trust values to classify the plurality of IoT nodes into a legitimate node or a malicious node before commencement of a transaction; and
facilitate decentralized node authentication, wherein the at least one hardware processor is configured to:
receive the new node digital certificate from the IoT node, and verify an authenticity of the IoT node based on the new node digital certificate,
encrypt a data packet with symmetric key using a symmetric encryption technique and encrypt the symmetric key with public key of the fog server using an asymmetric encryption technique,
decrypt encrypted symmetric key using private key of the fog server to access the data packet for validation and validate the data packet based on assessed trust value, and
construct a blockchain block comprising validated transaction data from the IoT node thereby participate in a Proof-of-Work consensus process to validate and add the blockchain block to a decentralized ledger shared among the plurality of fog servers.
